(19) United States
(12) Patent Application Publication
(10) Pub. No.: US 2025/0392732 A1
(43) Pub. Date: Dec. 25, 2025

(54) CODING METHOD, CODER, ELECTRONIC DEVICE, AND STORAGE MEDIUM

(71) Applicant: GUANGDONG OPPO MOBILE TELECOMMUNICATIONS CORP., LTD., Dongguan (CN)

(72) Inventor: Chuang MA, Dongguan (CN)

(73) Assignee: GUANGDONG OPPO MOBILE TELECOMMUNICATIONS CORP., LTD., Dongguan (CN)

(21) Appl. No.: 19/306,427

(22) Filed: Aug. 21, 2025

Related U.S. Application Data
(63) Continuation of application No. PCT/CN2023/088432, filed on Apr. 14, 2023.

(51) Int. Cl. H04N 19/167; H04N 19/103; H04N 19/14; H04N 19/196

(52) U.S. Cl. CPC H04N 19/167; H04N 19/103; H04N 19/14; H04N 19/196

(57) ABSTRACT

Embodiments of the present application provide a coding method, a coder, an electronic device, and a storage medium. The coding method comprises: determining at least one residual value on the basis of an original value of geometric position information of a current point and a reconstruction value of geometric position information of at least one candidate point, the at least one residual value comprising a first residual value; before coding the first residual value, determining the codeword length of the at least one residual value; on the basis of the codeword length of the at least one residual value, determining that a predicted residual value of the geometric position information of the current point comprises the first residual value; and coding the first residual value.

### TECHNICAL FIELD

This application is a continuation of International Application No. PCT/CN2023/088432, filed on Apr. 14, 2023, the disclosure of which is hereby incorporated by reference in its entirety.

### TECHNICAL FIELD

Embodiments of this application relate to the field of coding technologies, and more specifically, to an encoding method, an encoder, an electronic device, and a storage medium.

### BACKGROUND

Point clouds are widely applied in various fields, such as virtual/augmented reality, robotics, geographic information systems, and medicine. With continuous improvement of accuracy and speeds of scanning devices, a large number of point clouds on surfaces of objects can be accurately obtained, and usually hundreds of thousands of points may be obtained in one scene. Such a huge number of points poses challenges to computer storage and transmission. Therefore, compression of points becomes a hot issue.

For point cloud compression, geometric information and attribute information of a point cloud need to be mainly compressed. Specifically, an encoder first perform octree partitioning on geometric information of a point cloud, and then performs, by using an entropy encoding algorithm, entropy encoding on geometric information expressed in an octree structure, to obtain a geometric bitstream. In addition, the encoder reconstructs the geometric information based on the geometric information expressed in the octree structure, predicts attribute information of a current point based on the reconstructed geometric information, obtains a residual value of the current point based on a difference between an original value of the attribute information and the predicted attribute information, then quantizes the residual value to obtain a quantized residual value, and performs entropy encoding on the quantized residual value by using the entropy encoding algorithm to obtain an attribute bitstream.

However, how to improve an encoding speed of the encoder and reduce encoding complexity of the encoder is still a technical problem that needs to be solved urgently in this field.

### SUMMARY

Embodiments of this application provide an encoding method, an encoder, an electronic device, and a storage medium, so that an encoding speed of the encoder can be improved and encoding complexity of the encoder can be reduced.

According to a first aspect, an embodiment of this application provides an encoding method, including:
determining at least one residual value based on an original value of geometric position information of a current point and a reconstructed value of geometric position information of at least one candidate point, where the at least one residual value includes a first residual value;
determining a codeword length of the at least one residual value, before the first residual value is encoded;
determining, based on the codeword length of the at least one residual value, that a predicted residual value of the geometric position information of the current point includes the first residual value; and encoding the first residual value.

According to a second aspect, an embodiment of this application provides an encoder, including:
a first determining unit, configured to determine at least one residual value based on an original value of geometric position information of a current point and a reconstructed value of geometric position information of at least one candidate point, where the at least one residual value includes a first residual value;
a second determining unit, configured to: determine a codeword length of the at least one residual value before the first residual value is encoded;
a third determining unit, configured to: determine, based on the codeword length of the at least one residual value, that a predicted residual value of the geometric position information of the current point includes the first residual value; and an encoding unit, configured to encode the first residual value.

According to a third aspect, an embodiment of this application provides an encoder, including:
a processor, configured to implement computer instructions; and
a computer-readable storage medium, where the computer-readable storage medium stores computer instructions, and the computer instructions are loaded by the processor to execute the encoding method according to the first aspect or the implementations of the first aspect described above.

In an implementation, there are one or more processors, and there are one or more memories.

In an implementation, the computer-readable storage medium may be integrated with the processor, or the computer-readable storage medium is disposed separately from the processor.

According to a fourth aspect, an embodiment of this application provides a computer-readable storage medium. The computer-readable storage medium stores computer instructions, and the computer instructions are read and executed by a processor of a computer device to cause the computer device to execute the encoding method according to the first aspect described above.

According to a fifth aspect, an embodiment of this application provides a computer program product or a computer program, where the computer program product or the computer program includes computer instructions, and the computer instructions are stored in a computer-readable storage medium. The processor of the computer device reads the computer instructions from the computer-readable storage medium, and the processor executes the computer instructions, so that the computer device executes the encoding method according to the first aspect described above.

According to a sixth aspect, an embodiment of this application provides a bitstream, and the bitstream is a bitstream generated by using the method according to the first aspect described above.

Based on the foregoing technical solutions, at least one residual value is determined based on an original value of geometric position information of a current point and a reconstructed value of geometric position information of at least one candidate point, where the at least one residual value includes a first residual value; before the first residual value is encoded, a codeword length of the at least one residual value is determined; it is determined, based on the codeword length of the at least one residual value, that a predicted residual value of the geometric position information of the current point includes the first residual value; and the first residual value is encoded . . .

### BRIEF DESCRIPTION OF DRAWINGS

FIG. 1 is an example of a point cloud image according to an embodiment of this application.

FIG. 2 is an enlarged partial view of the point cloud image shown in FIG. 1.

FIG. 3 is an example of a point cloud image from six viewing angles according to an embodiment of this application.

FIG. 4 is a schematic block diagram of a G-PCC encoding framework according to an embodiment of this application.

FIG. 5 is a schematic block diagram of a G-PCC decoding framework according to an embodiment of this application.

FIG. 6 is a schematic diagram of a plane according to an embodiment of this application.

FIG. 7 is a schematic diagram of a child node according to an embodiment of this application.

FIG. 8 is a schematic diagram of a plane identifier according to an embodiment of this application.

FIG. 9 is a schematic diagram of a sibling node according to an embodiment of this application.

FIG. 10 is a schematic diagram of intersection of lidars and nodes.

FIG. 11 is a schematic diagram of a neighboring node at a same partitioning depth and same coordinates according to an embodiment of this application.

FIG. 12 shows an example in which a current node is located at a low plane position of a parent node according to an embodiment of this application.

FIG. 13 shows an example in which a current node is located at a low plane position of a parent node according to an embodiment of this application.

FIG. 14 shows an example of predictive coding of plane position information of a lidar point cloud according to an embodiment of this application.

FIG. 15 is a schematic diagram of an IDCM encoding mode according to an embodiment of this application.

FIG. 16 shows an example of coordinate transformation of a point cloud obtained by a rotary lidar according to an embodiment of this application.

FIG. 17 shows an example of predictive coding in an X-axis or Y-axis direction according to an embodiment of this application.

FIG. 18 shows an example of predicting an angle of an X or Y plane by using a horizontal azimuth according to an embodiment of this application.

FIG. 19 shows an example of X-axis or Y-axis predictive coding according to an embodiment of this application.

FIG. 20 is a schematic diagram of reconstructing geometric information in a sub-block according to an embodiment of this application.

FIG. 21 shows an example of geometric inter encoding and decoding based on a prediction tree according to an embodiment of this application.

FIG. 22 is a schematic flowchart of an encoding method according to an embodiment of this application.

FIG. 23 is a schematic block diagram of an encoder according to an embodiment of this application.

FIG. 24 is a schematic block diagram of an electronic device according to an embodiment of this application.

### DESCRIPTION OF EMBODIMENTS

The following describes the technical solutions in embodiments of this application with reference to the accompanying drawings.

A point cloud is a set of irregularly distributed discrete points in space that express a spatial structure and surface properties of a three-dimensional object or three-dimensional scene.

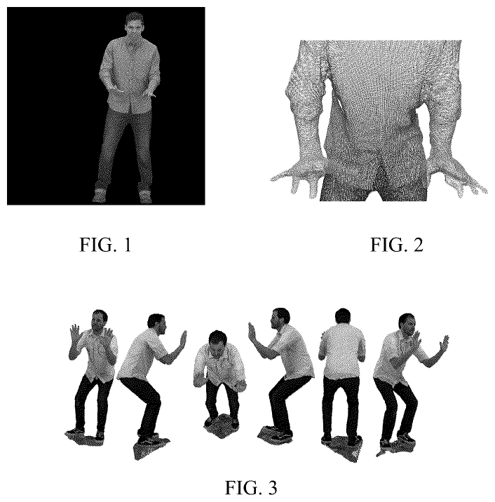

FIG. 1 and FIG. 2 show a three-dimensional point cloud image and a partial enlarged view of the point cloud image, respectively.

As shown in FIG. 1 or FIG. 2, a surface of a point cloud includes densely distributed points.

Samples of a two-dimensional image each express information and follow a distribution rule. Therefore, position information of the two-dimensional image is unnecessary to be additionally recorded. However, points in a point cloud are randomly and irregularly distributed in three-dimensional space. Therefore, a position of each point in the space needs to be recorded, to fully express the point cloud. Similar to the two-dimensional image, each point in the point cloud has corresponding attribute information, which is usually a color value. The color value reflects a color of an object. For the point cloud, in addition to a color, attribute information of each point may be a reflectance value, which reflects a surface material of the object. Each point in the point cloud may include geometric information and attribute information. The geometric information of each point in the point cloud refers to Cartesian three-dimensional coordinate data (x, y, z) of the point, and the attribute information of each point in the point cloud may include but is not limited to at least one of the following: color information, material information, or laser reflectance. The color information may be information in any color space. For example, the color information may be red-green-blue (RGB) information. For another example, the color information may alternatively be luminance-chrominance (YCbCr, YUV) information. Y indicates brightness (Luma), Cb (U) indicates a blue chroma component, and Cr (V) indicates a red chroma component. Each point in the point cloud has a same amount of attribute information. For example, each point in the point cloud has two types of attribute information: color information and laser reflectance. For another example, each point in the point cloud has three types of attribute information: color information, material information, and laser reflectance information.

A point cloud image may be viewed from a plurality of angles. For example, a point cloud image may have six viewing angles, as shown in FIG. 3.

A data storage format of the point cloud image includes a file header information part and a data part. The header information includes a data format, a data representation type, a total number of points included in point cloud, and content represented by the point cloud. For example, the data storage format of the point cloud image may be implemented in the following format:

ply
format ascii 1.0
element vertex 207242
property float x
property float y
property float z
property uchar red
property uchar green
property uchar blue
75 318 0 0 142 0
75 319 0 0 143 0
75 319 1 1 9 9
75 315 0 1 9 9

The data storage format of the foregoing point cloud image is in a “ply” format, and represented by ASCII code, with a total number of points being 207242, and each point has three-dimensional position information xyz and three-dimensional color information rgb.

A point cloud may flexibly and conveniently express a spatial structure and a surface attribute of a three-dimensional object or scene. Because the point cloud is obtained by directly performing sampling on a real object, an extremely strong sense of reality can be provided on a premise of ensuring precision. Therefore, the point cloud is widely applied in virtual reality gaming, computer-aided design, a geographic information system, an automatic navigation system, a digital cultural legacy, free viewpoint broadcasting, three-dimensional immersive remote presentation, three-dimensional reconstruction of a biological organ, and the like.

Point clouds may be classified into two categories based on application scenarios: machine-perceived point clouds and human-eye-perceived point clouds. Application scenarios of machine-perceived point clouds include, but are not limited to: point cloud application scenarios such as autonomous navigation systems, real-time inspection systems, geographic information systems, visual sorting robots, and emergency rescue robots. Application scenarios of human-eye-perceived point clouds include but are not limited to: point cloud application scenarios such as digital cultural heritage, free viewpoint broadcasting, three-dimensional immersive communication, and three-dimensional immersive interactions. Correspondingly, point clouds may be classified into dense point clouds and sparse point clouds based on point cloud obtaining manners; or point clouds may alternatively be classified into static point clouds and dynamic point clouds based on point cloud obtaining paths, and more specifically, may be classified into three categories of point clouds: static point clouds of category 1, dynamic point clouds of category 2, and dynamically acquired point clouds of category 3. For a static point cloud of category 1, an object is stationary and a device for obtaining a point cloud is also stationary; for a dynamic point cloud of category 2, an object is moving while a device for obtaining a point cloud is stationary; for a dynamically acquired point cloud of category 3, a device for obtaining a point cloud is moving.

Point cloud collection methods include but are not limited to: computer generation, 3D laser scanning, 3D photogrammetry, and the like. A computer may generate a point cloud of a virtual three-dimensional object or scene. 3D laser scanning may be performed to obtain a point cloud of a three-dimensional object or scene in a static real world, and can acquire millions of point clouds per second. 3D photographing measurement may be performed to obtain a point cloud of a three-dimensional object or scene in a dynamic real world, and can acquire tens of millions of point clouds per second. Specifically, a point cloud on a surface of an object may be collected through a collection device such as a photoelectric radar, a lidar, a laser scanner, or a multi-view camera. A point cloud obtained according to a laser measurement principle may include three-dimensional coordinate information and laser reflectance of a point. A point cloud obtained according to a photography measurement principle may include three-dimensional coordinate information and color information of a point. A point cloud obtained according to a laser measurement principle and a photography measurement principle may include three-dimensional coordinate information, laser reflectance, and color information of a point. These technologies reduce costs and time required for obtaining point cloud data and improve accuracy of data. For example, in the medical field, point clouds of biological tissues and organs may be obtained from magnetic resonance imaging (MRI), computed tomography (CT), and electromagnetic positioning information. These technologies reduce costs and time required for obtaining a point cloud and improve accuracy of data. A large amount of point cloud data may be acquired by using updated manners of acquiring point cloud data. With increasing application requirements, processing of massive 3D point cloud data is limited by storage space and transmission bandwidth.

A point cloud video with a frame rate (Frame Per Second, FPS) of 30 is used as an example. A number of points in each frame of the point cloud is 700,000, and each point in each frame of the point cloud has coordinate information xyz (float) and color information RGB (uchar). In this case, a data amount of a point cloud video with a duration of 10s is approximately 0.7 million×(4 bytes×3+1 byte×3)×30 fps×10s=3.15 GB. However, a data amount of a two-dimensional video with a duration of 10s a YUV sampling format of 4:2:0, a frame rate (Frame Per Second, FPS) of 24, and a resolution of 1280×720 is approximately 1280×720×12 bits×24 frames×10s˜0.33 GB. A data amount of a two-view 3D video with a duration of 10s is approximately 0.33×2=0.66 GB. It may be learned that a data amount of a point cloud video is far more than a data amount of a two-dimensional or three-dimensional video with same duration. Therefore, to better implement data management, save server storage space, and reduce transmission traffic and transmission time between servers and clients, point cloud compression is essential for promoting development of point cloud industries.

Point clouds may be encoded and decoded using various types of encoding and decoding frameworks. In an example, the encoding/decoding framework may be a geometric point cloud compression (G-PCC) encoding/decoding framework or a video point cloud compression (V-PCC) encoding/decoding framework provided by the Moving Picture Experts Group (MPEG), or may be an AVS-PCC encoding/decoding framework or point cloud compression reference platform (PCRM) framework provided by the Audio-video Standard (AVS) Working Group. The G-PCC encoding/decoding framework may be used to compress a static point cloud of category 1 and a dynamically acquired point cloud of category 3, and the V-PCC encoding/decoding framework may be used to compress a dynamic point cloud of category 2. The G-PCC encoding/decoding framework is also referred to as a point cloud codec TMC13, and the V-PCC encoding/decoding framework is also referred to as a point cloud codec TMC2. Both G-PCC and AVS-PCC may be used to compress static sparse point clouds, and their encoding frameworks are roughly the same.

The following uses G-PCC encoding/decoding framework as an example for description.

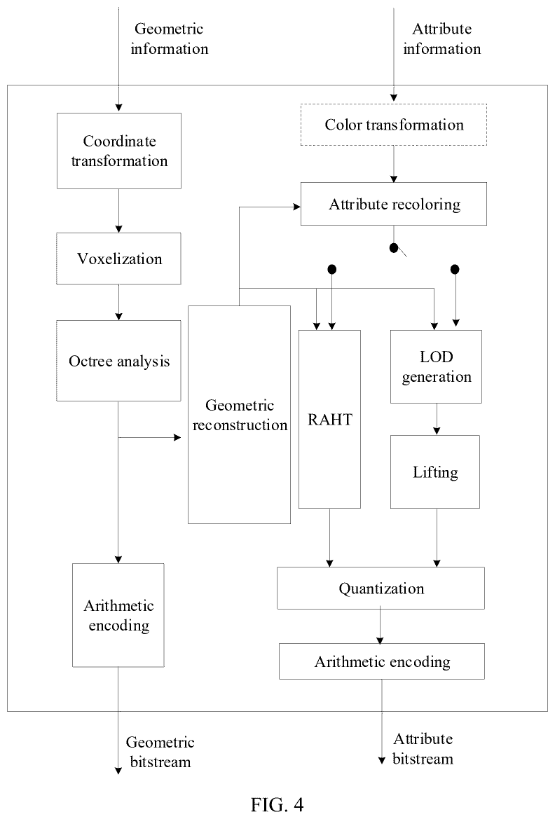

FIG. 4 is a schematic block diagram of a G-PCC encoding framework according to an embodiment of this application.

As shown in FIG. 4, in the G-PCC encoding framework, slice partitioning is first performed on an input point cloud, and then independent encoding is performed on slices obtained through partitioning. In the slices, geometric information of the point cloud and attribute information corresponding to points in the point cloud are separately encoded. G-PCC geometry coding may be classified into octree-based geometry coding and prediction tree-based geometry coding.

The G-PCC encoding framework reconstructs the geometric information after geometric information encoding is completed, and encodes attribute information of the point cloud by using reconstructed geometric information. Attribute encoding of a point cloud mainly includes encoding color information of points in the point cloud. First, the G-PCC encoding framework may perform color space conversion on color information of a point. For example, when color information of a point in the inputted point cloud is represented by using the RGB color space, the G-PCC encoding framework may convert the color information from an RGB color space to a YUV color space. Then, the G-PCC encoding framework re-colors the point cloud by using reconstructed geometric information, so that attribute information that is not encoded corresponds to the reconstructed geometric information. In color information encoding, there are mainly two transform methods. One method is distance-based lifting transform depending on level of detail (LOD) partitioning, and the other method is directly performing region adaptive hierarchal transform (RAHT). Both methods transform color information from a spatial domain to a frequency domain to obtain a high-frequency coefficient and a low-frequency coefficient. Finally, the coefficients are quantized and encoded, to generate a binary bitstream.

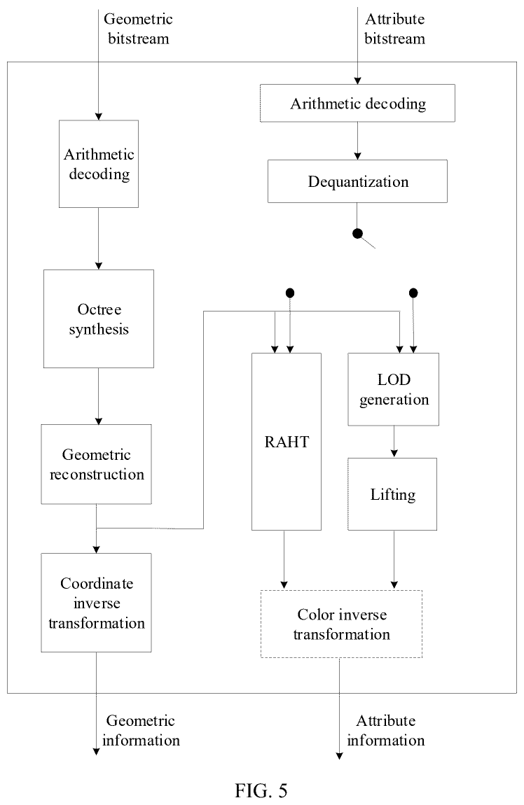

FIG. 5 is a schematic block diagram of a G-PCC decoding framework according to an embodiment of this application.

As shown in FIG. 5, the G-PCC decoding framework may obtain a bitstream of a point cloud from the G-PCC encoding framework, and obtain position information and attribute information of a point in the point cloud by parsing the bitstream. Decoding of the point cloud includes position decoding and attribute decoding. A position decoding process includes: performing arithmetic decoding on a geometric bitstream; reconstructing an octree based on decoded data, to reconstruct position information of a point, so as to obtain reconstructed information of the position information of the point; and performing coordinate transformation on the reconstructed information of the position information of the point to obtain the position information of the point. Position information of a point may also be referred to as geometric information of the point. An attribute decoding process includes: obtaining a residual value of attribute information of a point in a point cloud by attribute bitstream parsing; performing dequantization on the residual value of the attribute information of the point, to obtain a dequantized residual value of the attribute information of the point; selecting one of three prediction modes to perform point cloud prediction based on reconstructed information of the position information of the point obtained in the position decoding process, to obtain an attribute reconstructed value of the point; and performing color space inverse transform on the attribute reconstructed value of the point to obtain a decoded point cloud.

General test conditions for G-PCC

(1) There are four test conditions:
condition 1: a geometric position is limitedly lossy and an attribute is lossy;
condition 2: a geometric position is lossless, and an attribute is lossy;
condition 3: a geometric position is lossless and an attribute is limitedly lossy; and
condition 4: a geometric position is lossless and an attribute is lossless.

(2) General test sequences include four categories: Cat1A, Cat1B, Cat3-fused, and Cat3-frame. A Cat3-frame point cloud includes only reflectance attribute information, Cat1A and Cat1B point clouds include only color attribute information, and a Cat3-fused point cloud includes both color and reflectance attribute information.

(3) There are two types of technical approaches, which are distinguished by algorithms used for geometric compression.

Technical approach 1: Octree encoding branch.

On an encoding side, a bounding box is sequentially divided into sub-cubes, and a non-empty sub-cube (containing a point in the point cloud) is further divided until a leaf node obtained by partitioning is a 1×1×1 unit cube. In a case of geometric lossless encoding, the number of points contained in the leaf node is encoded, and finally encoding of a geometric octree is completed, to generate a binary bitstream.

A decoding side obtains a placeholder code of each node by performing continuous parsing in an order of breadth-first traversal, and sequentially perform node partitioning continuously until a 1×1×1 unit cube is obtained. In a case of geometric lossless decoding, the number of points contained in each leaf node is obtained by parsing, and finally geometric reconstructed point cloud information is recovered.

Technical approach 2: Prediction tree encoding branch.

On the encoding side, a prediction tree structure is established by using two different manners, including: KD-Tree (high-delay slow mode); and associating different points into different lasers by using lidar calibration information and establishing a prediction structure based on different lasers (low-delay fast mode). Next, based on the prediction tree structure, all nodes in the prediction tree are traversed, geometric position information of the nodes is predicted by selecting different prediction modes, to obtain prediction residuals, and the geometric prediction residuals are quantized by using a quantization parameter. Finally, the prediction residuals of position information of the prediction tree nodes, the prediction tree structure, the quantization parameter, and the like are encoded by continuous iterations, to generate a binary bitstream.

The decoding side continuously parses the bitstream to reconstruct a prediction tree structure, obtains prediction residual information of a geometric position of each prediction node and a quantization parameter by parsing, and dequantizes the prediction residual to recover reconstructed geometric position information of each node and finally completes geometric reconstruction.

The following describes technical content related to this application.

(I) Octree-based geometric encoding and decoding.

The octree-based geometric encoding includes:

First, coordinate transformation is performed on the geometric information so that a point cloud is entirely contained in a bounding box. Then, quantization is performed. The quantization is performed to achieve a scaling function. Due to rounding during quantization, some points have identical geometric information. It is determined whether to remove duplicate points based on a parameter. The process of quantization and removal of duplicate points is also referred to as a voxelization process. Next, tree partitioning (for example, octree/quadtree/binary tree) is continuously performed on the bounding box based on the order of breadth-first traversal, and the placeholder code of each node is encoded. In an implicit geometric partitioning manner, a bounding box (2^{d}, 2^{d}, 2^{d}) of a point cloud is first calculated, and it is assumed that the bounding box dₓ>d_{y}>d_{z} corresponds to a cuboid. During geometric partitioning, binary tree partitioning is first performed based on the x-axis to obtain two child nodes. When a condition dₓ=d_{y}>d_{z} is satisfied, quadtree partitioning is performed based on the x and y axes to obtain four child nodes. When a condition dₓ=d_{y}=d_{z} is satisfied, octree partitioning is performed until a leaf node obtained by partitioning is a 1×1×1 unit cube. A point in the leaf node is encoded, to generate a binary bitstream. In a process of partitioning based on binary tree/quadtree/octree, two parameters are introduced: K and M. The parameter K indicates a maximum number of times of binary tree/quadtree partitions before octree partitioning. The parameter M indicates that an edge length of a minimum block corresponding to binary tree/quadtree partitioning is 2^{M}. In addition, K and M need to satisfy the following conditions: assuming that dₘₐₓ=max (dₓ, d_{y}, d_{z}), dₘᵢₙ=min(dₓ, d_{y}, d_{z}), the parameter K satisfies K>=dₘₐₓ−dₘᵢₙ, and the parameter M satisfies M>=dₘᵢₙ. A reason for the parameters K and M to satisfy the foregoing conditions is that in a process of geometric implicit partitioning of G-PCC, the partitioning is performed based on an order of binary tree, quadtree, and octree; and a node is partitioned based on octree only when a block size of the node does not satisfy a binary tree/quadtree condition, until a leaf node with a minimum unit 1×1×1 is obtained through partition. In an octree-based geometric information encoding mode, geometric information of a point cloud may be effectively encoded by using correlation between adjacent points in space. For some relatively flat nodes or nodes with a planar characteristic, encoding efficiency of the geometric information of the point cloud can be further improved by using plane encoding.

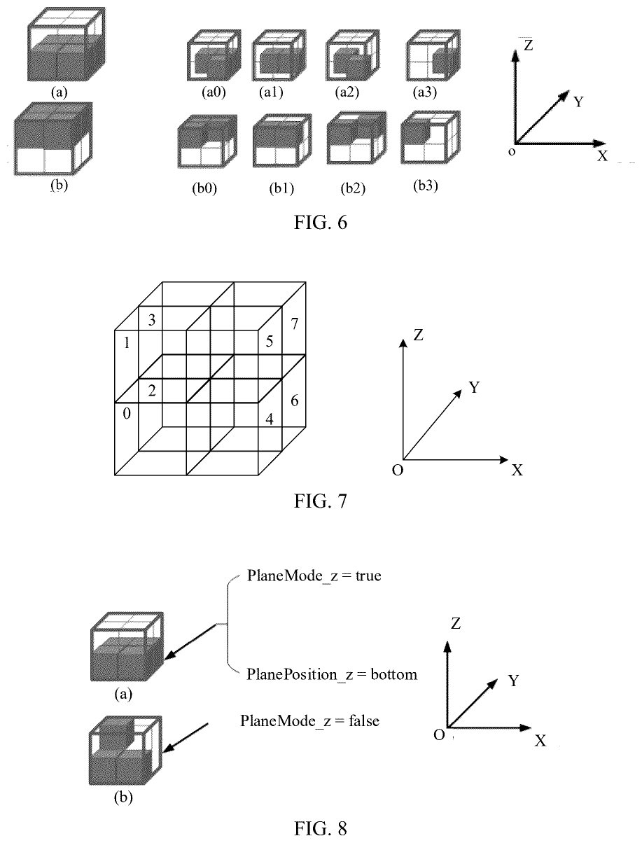

FIG. 6 is a schematic diagram of a plane according to an embodiment of this application.

As shown in FIG. 6, the (a) series indicate a low plane position in a Z-axis direction, and the (b) series indicate a high plane position in the Z-axis direction.

For the (a) series, four occupied subnodes in a current node shown by (a0), (a1), (a2), and (a3) are all located in a low plane position of the current node in the Z-axis direction. Therefore, it can be considered that the current node belongs to a Z plane and is a low plane in the Z-axis direction. For the (b) series, occupied subnodes in a current node shown by (b0), (b1), (b2), and (b3) are located at a high plane position of the current node in the Z-axis direction. Therefore, it can be considered that the current node belongs to the Z plane and is a high plane in the Z-axis direction.

The following uses (a) as an example to compare efficiencies of octree encoding and plane encoding.

If an octree encoding manner is used for (a) in FIG. 6, the placeholder information of the current node is represented as: 11001100. If a plane encoding manner is used, first, an identifier needs to be encoded to indicate that the current node is a plane in the Z-axis direction. Second, if the current node is a plane in the Z-axis direction, a plane position of the current node needs to be indicated. Third, only placeholder information of low plane nodes in the Z-axis direction (for example, placeholder information of four child nodes 0, 2, 4, and 6 shown in FIG. 7) needs to be encoded. Therefore, only 6 bits are needed to encoded when the current node is encoded based on the plane encoding manner, which can reduce 2 bits for representation compared with φ riginal octree encoding. Based on this analysis, plane encoding has a higher encoding efficiency than octree encoding. Therefore, for an occupied node, if plane encoding is used in a specific dimension, plane identification (planarMode) and plane position (PlanePos) information of a current node in this dimension needs to be indicated, and placeholder information of the current node is encoded based on the plane position information of the current node.

It should be noted that: for PlaneModei (i=0, 1, 2), 0 indicates that the current node is not a plane in an i-axis direction. When a node is a plane in the i-axis direction, for PlanePositionᵢ, 0 indicates that the current node is a plane in the i-axis direction and a plane position is a low plane, and 1 indicates that the current node is a high plane in the i-axis direction. For example, as shown in (a) in FIG. 8, if the current node is a plane in the z-axis direction and the plane position is a low plane, PlaneMode_z=true, and PlanePosition_z=bottom. For another example, as shown in (b) in FIG. 8, if the current node is not a plane in the z-axis direction, PlaneMode_z=false.

The following describes conditions for determining whether a node satisfies plane encoding.

Currently, there are three types of conditions for determining whether a node satisfies plane encoding condition in G-PCC, which are described one by one below.

Condition (1): determining whether a node at a current layer satisfies a plane encoding condition based on plane probability of the node in each dimension.

Whether a node satisfies plane encoding may be determined based on local area density (local_node_density) of the current node and probability Prob (i) of the current node in each dimension.

When the local area density of the node is less than a threshold Th (Th=3), plane probability Prob (i) of the current node in three dimensions is compared with thresholds Th0, Th1, and Th2, where Th0<Th1<Th2 (Th0=0.6, Th1=0.77, Th2=0.88). Eligiblei (i=0,1,2) is used to indicate whether plane encoding is enabled in each dimension:

$${Eligible}_{i} = Prob ( i ) >= threshold .$$

It should be noted that the threshold changes adaptively. For example, when Prob (0)>Prob (1)>Prob (2), the following is satisfied:

$${Eligible}_{0} = Prob ( 0 ) >= Th 0 ;$$

$${Eligible}_{1} = Prob ( 1 ) >= Th 1 ; and$$

$${Eligible}_{2} = Prob ( 2 ) >= Th 2.$$

When Prob (1)>Prob (0)>Prob (2), the following is satisfied:

$${Eligible}_{0} = Prob ( 0 ) >= Th 1 ;$$

$${Eligible}_{1} = Prob ( 1 ) >= Th 0 ; and$$

$${Eligible}_{2} = Prob ( 2 ) >= Th 2.$$

An update process of local_node_density and Prob (i) is specifically as follows:

$$Prob {( i )}_{new} = ( Lx Prob ( i ) + δ ( coded node ) ) / L + 1 .$$

Herein L=255, and when a “coded node” is a plane, δ is 1; otherwise, δ is 0.

$$local\_node {\_density}_{new} = local\_node \_density + 4 * numSiblings .$$

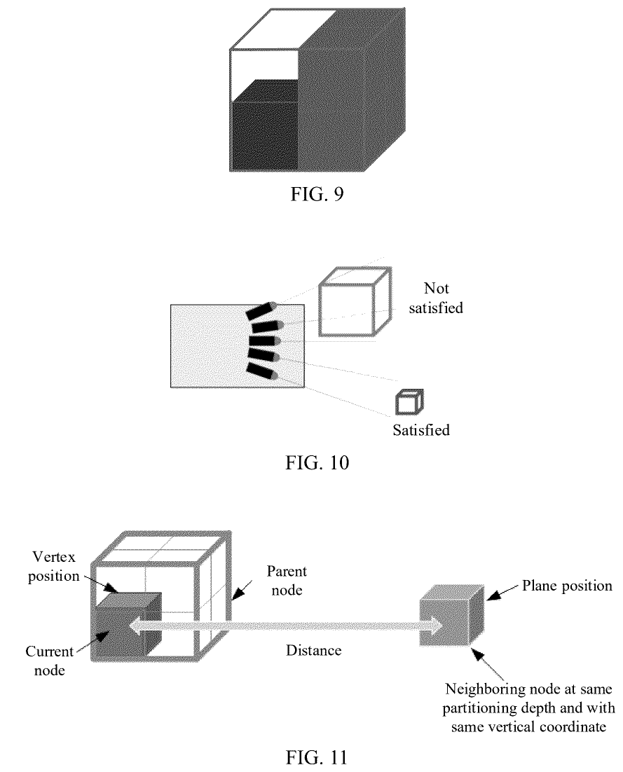

Herein, local_node_density is initialized to 4, and numSiblings is the number of sibling nodes of the node. For example, as shown in FIG. 9, the current node is a gray node on the left, and black nodes on the right are sibling nodes of the current node. In this case, the number of sibling nodes of the current node is 5 (including the current node itself).

Condition (2): determining, based on a point cloud density of a current layer, whether a node at the current layer satisfies a plane encoding condition.

It is determined whether to perform plane encoding on the node at the current layer based on density of points in the current layer. It is assumed that the number of points in a current point cloud to be encoded is pointCount, and the number of points reconstructed through IDCM encoding is numPointCountRecon. Because octree encoding is based on the order of breadth-first traversal, the number of nodes to be encoded at the current layer may be obtained, which is assumed to be nodeCount. In this case, it is determined whether to enable plane encoding for the current layer according to planarEligibleKOctreeDepth, which is as follows:

$$planarEligibleKOctreeDepth = ( pointCount - numPointCountRecon ) < nodeCount * 1.3 .$$

Herein, when planarEligibleKOctreeDepth is true, plane encoding is performed on all nodes at the current layer. Otherwise, only octree encoding is used instead of plane encoding.

Condition (3): determining whether a current node satisfies a plane encoding condition based on a collection parameter of a lidar point cloud.

FIG. 10 is a schematic diagram of intersection of lidars and nodes.

As shown in FIG. 10, it can be seen that a large node is traversed by two lidars (Laser) at the same time. Therefore, the current node is not a plane in a vertical direction of the Z axis, that is, the plane encoding condition is not satisfied. However, a small node is small enough so that the small node cannot be traversed by two lidars at the same time. Therefore, the small node may be a plane, that is, the plane encoding condition is satisfied.

For a node that satisfies a plane encoding condition, the following describes predictive encoding of plane identification information and plane position information.

(1) Predictive encoding of plane identification information.

Only three contexts are used for encoding, that is, a plane on each dimension indicates designing a respective context.

(2) Encoding of plane position information of non-lidar point cloud.

1. Plane position information of a current node is predicted by using placeholder information of a neighboring node, and a prediction result of the plane position information includes: predicted as a low plane, predicted as a high plane, and unpredictable.

2. A space distance between the current node and a node in a same partition depth and with same coordinates as the current node is “near” and “far”.

3. A node at a same partition depth and with same coordinates as the current node, is located at a same plane as the current node.

4. Coordinate dimension (i=0, 1, 2).

FIG. 11 is a schematic diagram of a neighboring node at a same partition depth and having same coordinates according to an embodiment of this application.

As shown in FIG. 11, for a to-be-encoded current node, a neighboring node is searched for under a same octree partitioning depth level and a same vertical coordinate, and a distance between the two nodes is determined as “near” and “far”, and reference is made to a plane position of the node.

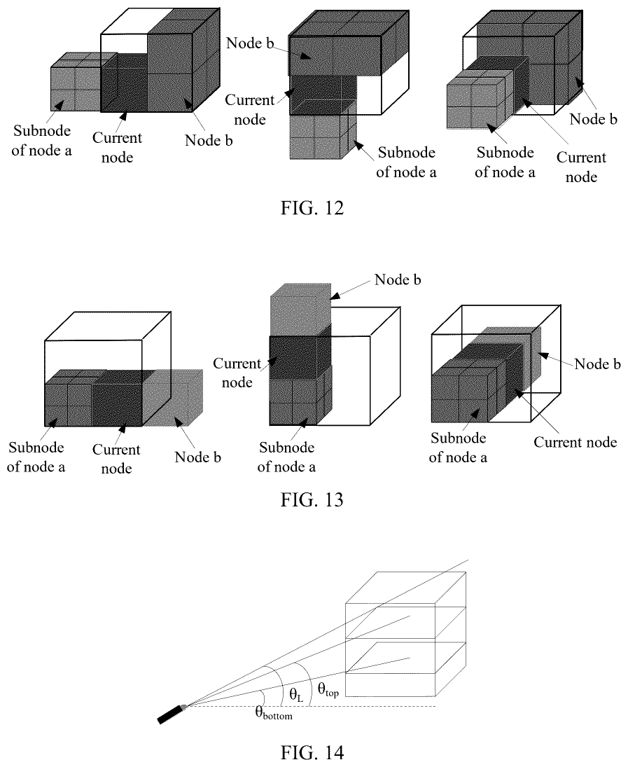

FIG. 12 shows an example in which a current node is located at a low plane position of a parent node according to an embodiment of this application.

As shown in FIG. 12, a neighboring node of the current node may include node b and child nodes of node a and. That is, plane position information of the current node may be predicted by using placeholder information of node b and the child nodes of node a, and the predicted position information includes three elements: predicted as a low plane, predicted as a high plane, and unpredictable.

Specifically, prediction may be performed in the following manners:

If one of child nodes 4 to 7 of node a is occupied, and none of nodes b is occupied, it is very likely that there is a plane in the current node, and the plane is at a low position. If none of child nodes 4 to 7 of node a is occupied, and one of nodes b is occupied, it is very likely that there is a plane in the current node, and the plane is located at a high position. If child nodes 4 to 7 of node a are empty nodes, and all nodes b are empty nodes, a plane position cannot be inferred and therefore is marked as unknown. If one of child nodes 4 to 7 of node a is occupied, and one of nodes b is occupied, a plane position cannot be inferred and is therefore marked as unknown.

FIG. 13 shows an example in which a current node is located at a low plane position of a parent node according to an embodiment of this application.

As shown in FIG. 13, a neighboring node of the current node may include node b and child nodes of node a. That is, plane position information of the current node may be predicted by using placeholder information of node b and the child nodes of node a, and the predicted plane position information includes three elements: predicted as a low plane, predicted as a high plane, and unpredictable.

Specifically, prediction may be performed in the following manners:

If one of child nodes 4 to 7 of node b is occupied, and node a is not occupied, it is very likely that there is a plane in the current node, and the plane is located at a low position. If none of child nodes 4 to 7 of node b is occupied, and node a is occupied, it is very likely that there is a plane in the current node, and the plane is located at a high position. If none of child nodes 4 to 7 of node b is occupied, and node a is not occupied, a plane position cannot be inferred and is therefore marked as unknown. If one of child nodes 4 to 7 of node b is occupied, and node a is occupied, a plane position cannot be inferred and is therefore marked as unknown.

(4) Encoding of plane position information of lidar point cloud.

A plane position of a current node is predicted by using a lidar collection parameter, and the plane position is quantized into four intervals by using an intersection position of the current node and a laser ray, and the four intervals finally serve as a context of the plane position of the current node. A specific calculation process is as follows: Assuming that coordinates of the lidar are (X_{Lidar}, Y_{Lidar}, Z_{Lidar}) and geometric coordinates of the current point are (x, y, z), a vertical tangent value tan θ of the current point relative to the lidar is first calculated. A calculation process is as follows:

$$tan θ = \frac{z - {z}_{Lidar}}{\sqrt{{( x - {x}_{Lidar} )}^{2} + {( y - {y}_{Lidar} )}^{2}}} .$$

Because each laser has a specific offset angle relative to the lidar, a relative tangent value tan θ_{corr.L} of the current node relative to the laser is calculated. A specific calculation process is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} .$$

Then, the plane position of the current node is predicted by using a corrected tangent value of the current node, which is specifically as follows.

FIG. 14 is an example of predictive encoding of plane position information of a lidar point cloud according to an embodiment of this application.

As shown in FIG. 14, assuming that a tangent value of a lower boundary of the current node is tan (θ_{bottom}), and a tangent value of an upper boundary of the current node is tan (θₜₒₚ). The plane position is quantized into four quantized intervals according to tan θ_{corr. L}, that is, a context of the plane position.

An octree-based geometric information encoding mode can compress only correlated points in space quickly, while a direct coding mode (DCM) can greatly reduce complexity for isolated points in geometric space. For all nodes in an octree, usage of the DCM is not represented by flag information, but is inferred by using information about a parent node and a neighbor of the current node.

There are three manners of determining whether the current node is eligible for DCM encoding:

(1) The current node has no sibling child nodes, that is, a parent node of the current node has only one child node, and a grandparent node of the current node has only two occupied child nodes. Therefore, the current node has at most one neighboring node.

(2) A parent node of the current node has only one occupied child node, that is, the current node, and six neighboring nodes that are coplanar with the current node are all empty nodes.

(3) The number of sibling nodes of the current node is greater than 1.

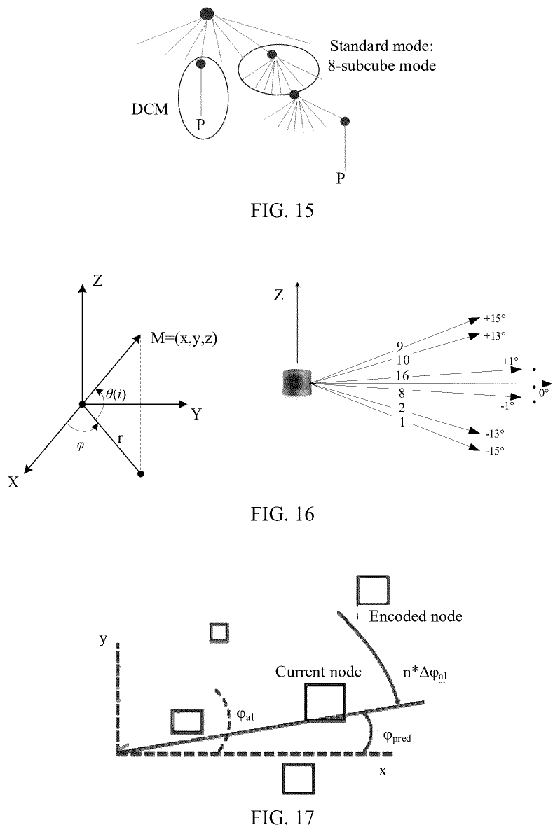

FIG. 15 is a schematic diagram of an IDCM encoding mode according to an embodiment of this application.

As shown in FIG. 15, if the current node is not eligible for DCM encoding, octree partition is performed on the current node; if the current node is eligible for DCM encoding, the number of points included in the current node is further determined; and when the number of points is less than a threshold 2, DCM encoding is performed on the current node; otherwise, octree partitioning continues. When the DCM encoding mode is used, it needs to encode whether the current node is a real isolated point, that is, IDCM_flag. If IDCM_flag is true, the current node uses DCM encoding. Otherwise, the current node still uses octree encoding. When the current node satisfies the DCM encoding, the DCM encoding mode for the current node needs to be encoded. Currently, there are two DCM modes: 1: There is only one point (or a plurality of points that are duplicate points). 2: There are two points. Finally, geometric information of each point needs to be encoded. Assuming that an edge length of a node is 2^{d} bits are required for encoding each component of geometric coordinates of the node, and the bit information is directly encoded into a bitstream. It should be noted herein that, when a lidar point cloud is encoded, predictive encoding is performed on coordinate information of three dimensions by using a lidar collection parameter, so that coding efficiency of geometric information can be further improved.

The following describes an IDCM encoding process in detail.

When the current node satisfies a direct encoding mode (DCM), the number of points numPoints of the current node is first encoded. The number of points of the current node is encoded based on different DirectMode, which is specifically as follows:

If the current node does not satisfy a requirement of a DCM node, (that is, the number of points is greater than 2 and the points are not duplicate points), the process ends.

If the number of points numPonts contained in the current node is less than or equal to 2, the encoding process is as follows:
(1) first encoding whether numPonts of the current node is greater than 1; and
(2) if the current node has only one point and geometric encoding is geometric lossless encoding, encoding that a 2^{nd} point of the current node is not a duplicate point.

If the number of points numPonts contained in the current node is greater than 2, the encoding process is as follows:
(1) first encoding that numPonts of the current node is less than or equal to 1; and
(2) then encoding that a 2nd point of the current node is a duplicate point, and then encoding whether a number of duplicate points of the current node is greater than 1; and when the number of duplicate points is greater than 1, performing exponential-Golomb decoding on the number of remaining duplicate points.

After the number of points of the current node is encoded, coordinate information of points included in the current node is encoded.

The following describes IDCM encoding processes separately for a lidar point cloud and a human eye-oriented point cloud.

(1) Human eye-oriented point cloud.

If the current node includes only one point, geometric information in three dimensional directions of the point is directly encoded (Bypass coding).

If the current node includes two points, an axis dirextAxis for preferential encoding is first obtained by using geometric coordinates of the points. It should be noted that coordinate axes include only the x and y axes, excluding the z axis. Assuming that geometric coordinates of the current node are nodePos, a determining manner is as follows:

$$dirextAxis = ! ( nodePos [ 0 ] < nodePos [ 1 ] ) .$$

That is, an axis with a smaller-coordinate geometric position of the node is used as a coordinate axis dirextAxis for preferential encoding, and then geometric information of the coordinate axis dirextAxis for preferential encoding is first encoded in the following manner. It is assumed that a to-be-encoded geometric bit depth corresponding to the axis for preferential encoding is nodeSizeLog2, and that coordinates of two points are pointPos[0] and pointPos[1] respectively.

```
Bool sameBit=true;
while(nodeSizeLog2&& sameBit){
  int mask=1<< nodeSizeLog2;
  --nodeSizeLog2;
  bool bit0=!!( pointPos[0]& mask)
  bool bit1=!!( pointPos[1]& mask)
  sameBits=bit0==bit1;
  entropyCodeSameBit(sameBits); ///<entropy coding
  if(sameBits)
  encodePosBit(bit0);///<Bypass coding
}.
```

After the axis dirextAxis for preferential encoding is encoded, geometric coordinates of the current point are directly encoded.

Assuming that a remaining encoding bit depth of each point is nodeSizeLog2, a specific encoding process is as follows:

$$for ( int axisIdx = 0 ; axisIdx < 3 ; ++ axisIdx )$$

$$for ( int mask = ( 1 << nodeSize Log 2 [ axisIdx ] ) >> 1 ; mask ; mask >> 1 )$$

$$encodePosBit ( ! ! ( pointPos [ axisIdx ] \& mask ) ) .$$

(2) Lidar-oriented point cloud.

If the current node includes two points, a coordinate axis dirextAxis for preferential encoding is first obtained by using geometric coordinates of the points. Assuming that geometric coordinates of the current node are nodePos, a determining manner is as follows:

$$dirextAxis = ! ( nodePos [ 0 ] < nodePos [ 1 ] ) .$$

That is, an axis with a smaller-coordinate geometric position of the node is used as a coordinate axis dirextAxis for preferential encoding. It should be noted that coordinate axes includes only the x and y axes, excluding the z axis. Then geometric information of the coordinate axis dirextAxis for preferential encoding is first encoded in the following manner. It is assumed that a to-be-encoded geometric bit depth corresponding to the axis for preferential encoding is nodeSizeLog2, and that coordinates of two points are pointPos[0] and pointPos[1] respectively.

```
Bool sameBit=true;
while(nodeSizeLog2&& sameBit){
  int mask=1<< nodeSizeLog2;
  --nodeSizeLog2;
  bool bit0=!!( pointPos[0]& mask)
  bool bit1=!!( pointPos[1]& mask)
  sameBits=bit0==bit1;
  entropyCodeSameBit(sameBits);
  if(sameBits)
  encodePosBit(bit0);
}.
```

After axis dirextAxis for preferential encoding is encoded, geometric coordinates of the current point are encoded.

Because a collection parameter of a lidar point cloud may be obtained from the lidar point cloud, geometric coordinate information of the current node may be predicted by using the collection parameter, so that encoding efficiency of geometric information of the point cloud can be further improved. Similarly, first, geometric information nodePos of the current node is used to obtain a directly encoded principal axis direction, and then predictive encoding is performed on geometric information of another dimension by using geometric information of an encoded direction. Also assuming that the axis direction for directly encoding is directAxis and a to-be encoded bit length in the direct encoding is nodeSizeLog2, an encoding manner is as follows:

for(int mask=(1<< nodeSizeLog2)>>1;mask;mask>>1)
encodePosBit(!!(pointPos[directAxis]&mask)).

It should be noted that geometric precision information in the directAxis direction is all encoded herein.

After all precisions of the directAxis coordinate direction are encoded, LaserIdx corresponding to the current point is first calculated. For example, as shown by a pointLaserIdx number in FIG. 16, and LaserIdx of the current node, namely, nodeLaserIdx, is calculated. Then, LaserIdx of the node, namely, nodeLaserIdx, is used to perform predictive encoding on LaserIdx of a point, namely, pointLaserIdx. A calculation manner of LaserIdx of the node or the point is as follows: Assuming that geometric coordinates of the point are pointPos, start coordinates of a laser ray are LidarOrigin, the number of lasers is LaserNum, a tangent value of each laser is tanei, and an offset position of each laser in a vertical direction is Zi, then:

```
Int bestLaserIdx=0;
Int Distoration=INT_MAX;
For(int LaserIdx=0; LaserIdx<numLaser;++ LaserIdx){
  int radius
    = \sqrt{(pointPos[0] − LidarOrigin[0])2 +}
    \sqrt{(pointPos[1] − LidarOrigin[1])2}
  int invRadius=1/ radius
  int Z=pointPos[2]+ Zᵢ
  int tanTheta = Z×invRadius
  if(std::abs(tanTheta-tanθᵢ)< Distoration){
    Distoration = std::abs(tanTheta-tanθᵢ);
    bestLaserIdx = LaserIdx;
  }
}.
```

After LaserIdx of the current node is calculated, predictive encoding is performed on pointLaserIdx of the point by using LaserIdx of the current node. After LaserIdx of the current point is encoded, predictive encoding is performed on geometric information of three dimensions of the current point by using a lidar collection parameter.

A specific algorithm is as follows.

As shown in FIG. 17, a predicted value of a corresponding horizontal azimuth, namely, φ_{pred}, is first obtained by using LaserIdx corresponding to the current point, and then a horizontal azimuth φ_{node} corresponding to the node is obtained by using node geometric information corresponding to the current point. Herein, a horizontal azimuth q may be calculated based on node geometry information according to:

$$φ = arctan ( nodePos [ 1 ] / nodePos [ x ] ) ,$$

where nodePos represents geometric coordinates of the node.

The number of rotated points numPoints of each laser, which represents the number of points obtained by rotating each laser ray by one circle, may be obtained by using a lidar collection parameter. In this case, a rotational angular velocity deltaPhi of each laser may be calculated by using the number of rotated points of each laser:

$$deltaPhi = \frac{2 π}{numPoints} .$$

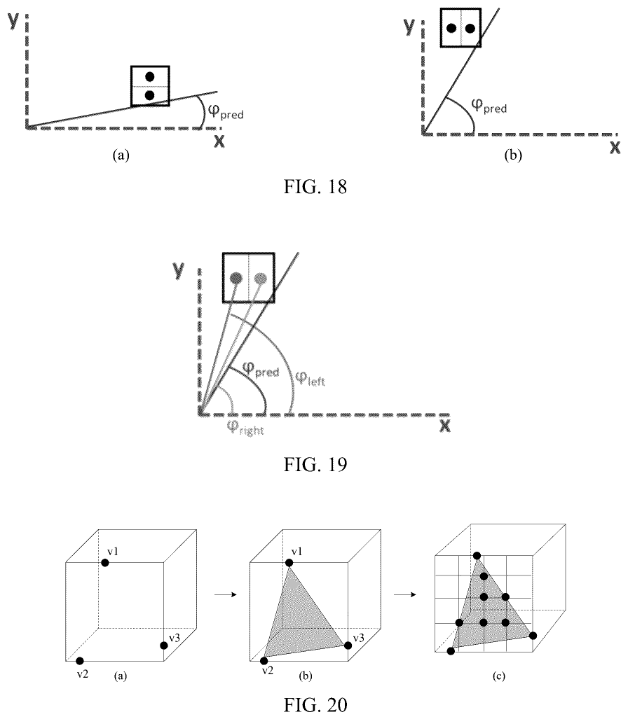

In this case, a horizontal azimuth predicted value φ_{predPoint} corresponding to the current point is calculated by using a horizontal azimuth φ_{node} of the node and a horizontal azimuth φ_{pred} of a previous coding point of a laser corresponding to the current point. The horizontal azimuth predicted value φ_{pred} is shown in FIG. 18. As shown in (a) in FIG. 18, an angle of a Y plane (y-planar predicted by azimuthal angle) may be predicted by using the horizontal azimuth. As shown in (b) in FIG. 18, an angle of an X plane (x-planar predicted by azimuthal angle) may be predicted by using the horizontal azimuth.

A calculation manner is as follows:

$${φ}_{predPoint} = \frac{{φ}_{pred} - {φ}_{node}}{deltaPhi} \times deltaPhi + {φ}_{pred} .$$

Finally, predictive encoding is performed on the geometric information of the current node by using the horizontal azimuth predicted value φ_{predPoint}, a horizontal azimuth φ_{left} of a low plane of the current node, and a horizontal azimuth φ_{right} of a high plane of the current node. A relationship between φ_{left}, φ_{right}, and φ_{pred} is shown in FIG. 19.

Details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert ( angLel < 0 \&\& angLeR < 0 ) ? 0 : 2 ;$$

$$int min Angle = std \text{::} min ( abs ( angLel ) , abs ( angLeR ) ) ;$$

$$int max Angle = std \text{::} max ( abs ( angLel ) , abs ( angLeR ) ) ;$$

$$context += max Angle > min Angle ? 0 : 1 ;$$

$$context += max Angle > min Angle ? 0 : 4.$$

After laserIdx of a point is encoded, predictive encoding is performed on the Z-axis direction of the current point by using laserIdx corresponding to the current point, that is, depth information radius of a cylindrical coordinate system is currently calculated by using x and y information of the current point. Then, a tangent value of the current point and an offset in the vertical direction are obtained by using laser LaserIdx of the current point, to obtain a predicted value in the Z-axis direction of the current point, that is, Z_pred:

$$int radius = \sqrt{( pointPos [ 0 ] - LidarOrigin [ 0 ] ) 2 + ( pointPos [ 1 ] - LidarOrigin [ 1 ] ) 2} ;$$

$$int tan Theta = tan {θ}_{laserIdx} ;$$

$$int zOffset = {Z}_{laserIdx} ;$$

$$Z\_pred = radius \times tan Theta - zOffset .$$

Finally, predictive encoding is performed on geometric information in the Z-axis direction of the current point by using Z_pred, to obtain predicted residual Z_res, and finally Z_res is encoded.

It should be noted that, when a node is partitioned into a leaf node, the number of duplicate points in the leaf node needs to be encoded in a case of geometric lossless encoding. Finally, placeholder information of all nodes is encoded to generate a binary bitstream. In addition, G-PCC currently introduces a plane encoding mode. In a process of geometric partitioning, it is determined whether child nodes of the current node are located on a same plane. If the child nodes of the current node are located a same plane, the plane is used to represent the child nodes of the current node.

For octree geometry decoding, before a decoding side decodes occupancy information of each node in a breadth-first traversal sequence, the decoding side first determines, by using reconstructed geometric information, whether to perform plane decoding or IDCM decoding on a current node. If the current node satisfies a plane decoding condition, the decoding side first decodes a plane identifier and plane position information of the current node, and then decodes, based on plane information, occupancy information of the current node. If the current node satisfies an IDCM decoding condition, the decoding side first decodes whether the current node is a real IDCM node. If the current node is a real IDCM node, the decoding side parses a DCM decoding mode of the current node, and then may obtain the number of points in the current DCM node. Finally, the decoding side decodes geometric information of each point. For a node that satisfies neither the plane decoding condition nor the DCM decoding condition, occupancy information of the current node is decoded. In this manner, an occupancy code of each node is obtained through continuous parsing, and nodes are successively partitioned until 1×1×1 unit cubes are obtained. The number of points included in each leaf node is obtained through parsing, and finally, reconstructed geometric information of a point cloud is restored.

The following describes an IDCM decoding process in detail.

The process is similar to that of encoding. First, prior information is used to determine whether to start the IDCM. That is, IDCM startup conditions are as follows:

(1) The current node has no sibling child nodes, that is, a parent node of the current node has only one child node, and a grandparent node of the current node has only two occupied child nodes. Therefore, the current node has at most one neighboring node.

(2) A parent node of the current node has only one occupied child node, that is, the current node, and six neighboring nodes that are coplanar with the current node are all empty nodes.

(3) The number of sibling nodes of the current node is greater than 1.

When the node satisfies a DCM encoding condition, whether the current node is a real DCM node is first decoded, that is, IDCM_flag. If IDCM_flag is true, the current node uses DCM encoding. Otherwise, the current node still uses octree encoding.

Then, the number of points numPoints of the current node is decoded. A specific decoding mode is as follows:

First, whether numPonts of the current node is greater than 1 is decoded.

If it is obtained through decoding that numPonts of the current node is greater than 1, whether a 2nd point is a duplicate point is further decoded. If the 2nd point is not a duplicate point, it may be implicitly inferred that DCM mode 2 is satisfied, and only two points are included.

If it is obtained through decoding that numPonts of the current node is less than or equal to 1, whether the 2nd point is a duplicate point is further decoded. If the 2nd point is not a duplicate point, it may be implicitly inferred that DCM mode 1 is satisfied, and only one point is included. If it is obtained through decoding that the 2nd point is a duplicate point, it may be inferred that the DCM mode 3 is satisfied, and a plurality of points are included and all of the plurality of points are duplicate. Then, whether the number of duplicate points is greater than 1 is further decoded (entropy decoding). If the number of duplicate points is greater than 1, the number of remaining duplicate points is further decoded (by using exponential-Golomb).

If the current node does not satisfy a requirement of a DCM node, (that is, the number of points is greater than 2 and the points are not duplicate), the process ends.

After the number of points of the current node is decoded, coordinate information of points included in the current node is decoded.

The following describes IDCM decoding processes separately for a lidar point cloud and a human eye-oriented point cloud.

(1) Human eye-oriented point cloud.

If the current node includes only one point, geometric information in three dimensional directions of the point is directly decoded (Bypass coding).

If the current node includes two points, a coordinate axis dirextAxis for preferential decoding is obtained by using geometric coordinates of the points. It should be noted that coordinate axes includes only the x and y axes, excluding the z axis. Assuming that geometric coordinates of the current node are nodePos, a determining manner is as follows:

$$dirextAxis = ! ( nodePos [ 0 ] < nodePos [ 1 ] ) .$$

That is, an axis with a smaller-coordinate geometric position of the node is used as a coordinate axis dirextAxis for preferential decoding, and then geometric information of the coordinate axis dirextAxis for preferential decoding is first decoded in the following manner. It is assumed that a to-be decoded geometric bit depth corresponding to the axis for preferential decoding is nodeSizeLog2, and that coordinates of two points are pointPos [0] and pointPos [1] respectively.

```
  Bool sameBit=true;
  while(nodeSizeLog2&& sameBit){
    pointPos[0][ dirextAxis]<<1;
    pointPos[1][ dirextAxis]<<1;
    --nodeSizeLog2;
    int bit=0;
    deEntropyCodeSameBit(sameBits); ///<entropy coding
    if(sameBits){
      bit = decodePosBit( );///<Bypass coding
      pointPos[0][ dirextAxis]| = bit
      pointPos[1][ dirextAxis]| = bit
    }else
  pointPos[1][dirextAxis]| = 1///< During encoding, two points are sorted in a direction of
axis for preferential encoding. Therefore, pointPos[0][ dirextAxis] < pointPos[1][ dirextAxis]
may be ensured. Therefore, during decoding, if bit information of the two points is different, it
may be inferred that a bit of the 1^{st} point is 0, and a bit of the 2^{nd} point is 1.
  }.
```

After the axis dirextAxis for preferential decoding is decoded, geometric coordinates of the current point are directly decoded. Assuming that a remaining coding bit depth of each point is nodeSizeLog2, a specific decoding process is as follows. It is assumed that coordinate information of the point is pointPos.

```
for(int axisIdx=0;axisIdx<3;++axisIdx)
  for(int idx = nodeSizeLog2[axisIdx]; idx; idx--){
    pointPos[axisIdx]<<1;
    pointPos[axisIdx]|=decodePosBit( );
}.
```

(2) Lidar-oriented point cloud.

(a) If the current node includes two points, an axis dirextAxis for preferential decoding is first obtained by using geometric coordinates of the points. Assuming that geometric coordinates of the current node is nodePos, a determining manner is as follows: dirextAxis=! (nodePos [0]<nodePos [1]).

That is, an axis with a smaller-coordinate geometric position of the node is used as a coordinate axis dirextAxis for preferential decoding. It should be noted that coordinate axes includes only the x and y axes, excluding the z axis. Then geometric information of the coordinate axis dirextAxis for preferential encoding is first decoded in the following manner. It is assumed that a to-be-encoded geometric bit depth corresponding to the axis for preferential decoding is nodeSizeLog2, and that coordinates of two points are pointPos [0] and pointPos [1] respectively.

```
  Bool sameBit=true;
  while(nodeSizeLog2&& sameBit){
  pointPos[0][ dirextAxis]<<1;
  pointPos[1][ dirextAxis]<<1;
  --nodeSizeLog2;
  int bit=0;
  deEntropyCodeSameBit(sameBits); ///<entropy coding
  if(sameBits){
    bit = decodePosBit( );///<Bypass coding
    pointPos[0][ dirextAxis]| = bit
    pointPos[1][ dirextAxis]| = bit
    }else
  pointPos[1][ dirextAxis]| = 1///< during encoding, two points are sorted in a direction of
axis for preferential encoding. Therefore, pointPos[0][ dirextAxis] < pointPos[1][ dirextAxis]
may be ensured. Therefore, during decoding, if bit information of the two points is different, it
may be inferred that a bit of the 1^{st} point is 0, and a bit of the 2^{nd} point is 1.
  }.
```

After the axis dirextAxis for preferential decoding is decoded, geometric coordinates of the current point are decoded.

Similarly, the decoding side first uses geometric information nodePos of the current node to obtain a directly decoded principal axis direction, and then geometric information of another dimension is decoded by using geometric information of a decoded direction. Also assuming that the directly decoded axis direction is directAxis and a to-be decoded bit length in the direct decoding is nodeSizeLog2, a decoding manner is as follows:

```
for(int idx = nodeSizeLog2[directAxis]; idx; idx--){
  pointPos[directAxis]<<1;
  pointPos[directAxis]|=decodePosBit( );
}.
```

It should be noted that geometric precision information in the directAxis direction is all decoded herein.

After all precisions of the directAxis coordinate direction are decoded, LaserIdx of the current node, namely, nodeLaserIdx, is first calculated. Then, LaserIdx of the node, namely, nodeLaserIdx, is used to perform predictive decoding on LaserIdx of a point, namely, pointLaserIdx. A calculation manner of LaserIdx of the node or the point is the same as that on the encoding side. Finally, laserIdx of the current point and laserIdx prediction residual information of the node are decoded, to obtain the ResLaserIdx. Then:

$$PointLaserIdx = nodeLaserIdx + ResLaserIdx .$$

After LaserIdx of the current point is decoded, predictive decoding is performed on geometric information of three dimensions of the current point by using a lidar collection parameter. A specific algorithm is as follows.

A predicted value of a corresponding horizontal azimuth, namely, φ_{pred}, is first obtained by using LaserIdx corresponding to the current point, and then a horizontal azimuth Pode corresponding to the node is obtained by using node geometric information corresponding to the current point. Herein, a horizontal azimuth q may be calculated based on node geometry information according to

$$φ = arctan ( nodePos [ 1 ] / nodePos [ 0 ] ) ,$$

where nodePos represents geometric coordinates of the node.

The number of rotated points numPoints of each laser, which represents the number of points obtained by rotating each laser ray by one circle, may be obtained by using a lidar collection parameter. In this case, a rotational angular velocity deltaPhi of each laser may be calculated by using the number of rotated points of each laser:

$$deltaPhi = \frac{2 π}{numPoints} .$$

In this case, a horizontal azimuth predicted value φpredPoint corresponding to the current point is calculated by using a horizontal azimuth Pnode of the node and a horizontal azimuth φ_{pred} of a previous coding point of a laser corresponding to the current point, as shown the horizontal azimuth predicted value in FIG. 12. A calculation manner is as follows:

$${φ}_{predPoint} = \frac{φ pred - φ node}{deltaPhi} \times deltaPhi + φ pred .$$

Finally, predictive decoding is performed on the geometric information of the current node by using the horizontal azimuth predicted value φpredPoint, a horizontal azimuth φ_{left} of a low plane of the current node, and a horizontal azimuth φ_{right} of a high plane of the current node. Details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert ( angLel < 0 \&\& angLeR < 0 ) ? 0 : 2 ;$$

$$int absAngleL = abs ( angLel ) ,$$

$$int absAngleR = abs ( angLeR ) ;$$

$$context += absAngleL > absAngleR ? 0 : 1 ;$$

$$context += max Angle > min Angle << 1 ? 4 : 0 .$$

After laserIdx of a point is decoded, predictive decoding is performed on the Z-axis direction of the current point by using laserIdx corresponding to the current point. That is, depth information radius of a cylindrical coordinate system is calculated by using x and y information of the current point. Then, a tangent value of the current point and an offset in the vertical direction are obtained by using laser LaserIdx of the current point, to obtain a predicted value in the Z-axis direction of the current point, that is, Z_pred:

$$int radius = \sqrt{( pointPos [ 0 ] - LidarOrigin [ 0 ] ) 2 + ( pointPos [ 1 ] - LidarOrigin [ 1 ] ) 2} ;$$

$$int tan Theta = tan {θ}_{laserIdx} ;$$

$$int zOffset = {Z}_{laserIdx} ;$$

$$Z\_pred = radius \times tan Theta - zOffset .$$

Finally, Z_res and Z_pred obtained by decoding are used to reconstruct and recover geometric information in the Z-axis direction of the current point.

(II) Encoding of geometric information based on triangle soup (triangle soup, trisoup).

In a trisoup-based geometric information encoding framework, geometric partition is also required first; but different from geometric information encoding based on binary tree/quadtree/octree, it is unnecessary to partition a point cloud into unit cubes with edge lengths of 1×1×1. Instead, when an edge length of a block (sub-block) is W, the partitioning is stopped; and based on a surface formed by distribution of the point cloud in each block, at most twelve vertices (vertex) generated by the surface and twelve edges of the block are obtained. Vertex coordinates of all blocks are sequentially encoded to generate a binary bitstream.

When the decoding side reconstructs point cloud geometry information, vertex coordinates are first decoded to complete triangle soup reconstruction.

FIG. 20 is a schematic diagram of reconstructing geometric information in a sub-block according to an embodiment of this application.

As shown in FIG. 20, there are three vertices (vertex) (v1, v2, v3) in a block (block) shown in (a) in FIG. 20. As shown in (b) in FIG. 20, a triangle soup formed by using the three vertices in a specific order is referred to as a triangle soup, namely, trisoup. Then, as shown in (c) in FIG. 19, sampling is performed on the triangle soup, and obtained sampling points are used as a reconstructed point cloud in the block.

(III) Geometry encoding and decoding based on prediction tree.

The prediction tree-based geometric encoding includes:

First, an input point cloud is sorted, and current sorting methods include unordered, Morton order, azimuth order, and radial distance order. On the encoding side, a prediction tree structure is established by using two different manners, including: KD-Tree (high-delay slow mode); and associating different points into different lasers by using lidar calibration information and establishing a prediction structure based on different lasers (low-delay fast mode). Next, based on the prediction tree structure, all nodes in the prediction tree are traversed, geometric position information of the nodes is predicted by selecting different prediction modes, to obtain prediction residuals, and the geometric prediction residuals are quantized by using a quantization parameter. Finally, the prediction residuals of position information of the prediction tree nodes, the prediction tree structure, the quantization parameter, and the like are encoded by continuous iterations to generate a binary bitstream.

For prediction tree-based geometry decoding, a decoding side continuously parses the bitstream to reconstruct a prediction tree structure, obtains prediction residual information of a geometric position of each prediction node and a quantization parameter through the parsing, and dequantizes the prediction residual to obtain reconstructed geometric position information of each node and finally complete geometric reconstruction on the decoding side.

After the geometric encoding is completed, the geometric information is reconstructed. Attribute encoding is mainly performed for color information. First, the color information is converted from an RGB color space to a YUV color space. Then, the point cloud is re-colored by using the reconstructed geometric information, so that attribute information that is not encoded corresponds to the reconstructed geometric information. In color information encoding, there are mainly two transform methods. One method is distance-based lifting transform depending on LOD (Level of Detail) partitioning, and the other method is directly performing RAHT (Region Adaptive Hierarchal Transform, region adaptive hierarchal transform). Both methods transform color information from a spatial domain to a frequency domain to obtain a high-frequency coefficient and a low-frequency coefficient. Finally, the coefficients are quantized and encoded, to generate a binary bitstream.

When the attribute information is predicted by using the geometric information, a Morton code may be used to search for a nearest neighbor. A Morton code corresponding to each point in the point cloud may be obtained by using geometric coordinates of the point. A specific method for calculating the Morton code is described as follows. For each component, three-dimensional coordinates are represented by a d-bit binary number, and the three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} .$$

Herein, [symbol] , [symbol] , [symbol] ∈ {0,1} are respectively binary values corresponding to x, y, and z from a highest bit ( [symbol] =1) to a lowest bit ( [symbol] =d). The Morton code Mis generated by alternate arrangement [symbol] , [symbol] , [symbol] of x, y, and z from the highest bit to the lowest bit. A calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} .$$

Herein, mₗ′∈{0,1} is values of M from the highest bit ( [symbol] =1) to the lowest bit ( [symbol] =3d). After obtaining the Morton code M of each point in the point cloud, points in the point cloud are arranged in ascending order of Morton codes, and a weight w of each point is set to 1.

(IV) Geometry inter encoding and decoding based on prediction tree.

Point coordinates of an input point cloud are (x, y, z). Prior radar information of the current point cloud is used to transform position information of the point cloud is into (radius, φ, laserIdx).

A calculation manner of LaserIdx of a node or point is as follows:

Assuming that geometric coordinates of the point are pointPos, start coordinates of a laser ray are LidarOrigin, the number of lasers is LaserNum, a tangent value of each laser is tanei, and an offset position of each laser in a vertical direction is Zi, then:

```
Int bestLaserIdx=0;
Int Distoration=INT_MAX;
For(int LaserIdx=0; LaserIdx<numLaser;++ LaserIdx){
  int radius
    = \sqrt{(pointPos[0] − LidarOrigin[0])2 +}
    \sqrt{(pointPos[1] − LidarOrigin[1])2}
  int invRadius=1/ radius
  int Z=pointPos[2]+Zᵢ
  int tanTheta = Z×invRadius
  if(std::abs(tanTheta-tanθᵢ)< Distoration){
    Distoration = std::abs(tanTheta-tanθᵢ);
    bestLaserIdx = LaserIdx;
  }
}.
```

Assuming that geometric coordinates of the node are pointPos, then:

$$φ = arctan ( pointPos [ 1 ] / pointPos [ 0 ] ) ;$$

$$radius = \sqrt{( pointPos [ 0 ] - LidarOrigin [ 0 ] ) 2 + ( pointPos [ 1 ] - LidarOrigin [ 1 ] ) 2.}$$

LidarOrigin is usually 0.

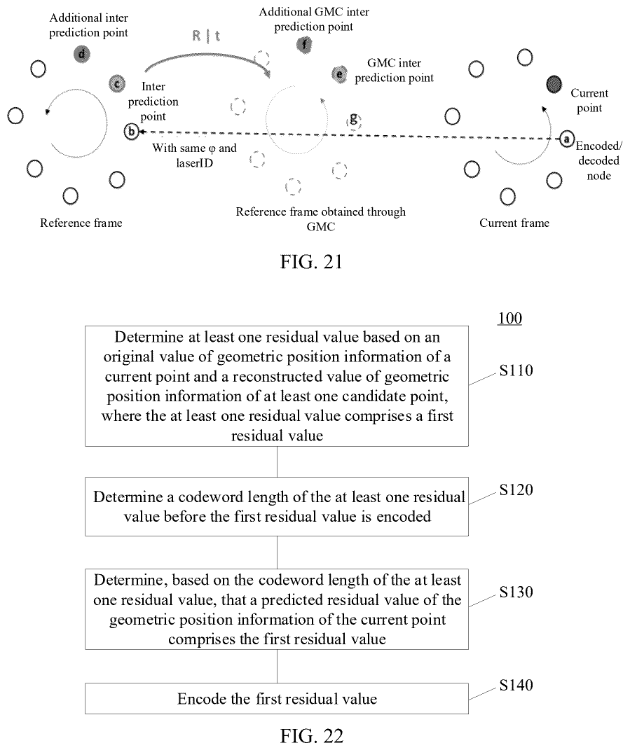

FIG. 21 shows an example of geometric inter encoding and decoding based on a prediction tree according to an embodiment of this application.

As shown in FIG. 21, when an encoder performs inter-frame predictive encoding on a to-be-encoded current point, the predictive encoding may be performed through the following procedure:

(1) a prediction tree is traversed and a previous encoded point of the to-be-encoded current point is marked as point a.

(2) point b is searched for in a reference frame of the current point, where point b is a point with a same φ and a same laserID as point a, or point b is a 1^{st} point with a same laserID as point a and with φ less than or equal to φ of point a; and a 1^{st} point with a same laserID as point a and with φ greater than φ of point b in the reference frame is marked point c, and a 1^{st} point with a same laserID as point a and with φ greater than φ of point c in the reference frame is marked as point d. Points c and d are used as inter-frame candidate points for the current point.

(3) A GMC reference frame is obtained by performing global motion compensation (global motion compensation, GMC) on the reference frame; point g is searched for in the CMC reference frame, where point g is a point with a same φ and a same laserID as point a, or point g is a 1^{st} point with a same laserID as point a and with φ less than or equal to φ of point a; a 1^{st} point with a same laserID as point g and with φ greater than φ of point g in the GMC reference frame is marked as point e, and a 1^{st} point with a same laserID as point a and with 4 greater than φ of point e in the GMC reference frame is marked as point f. Points e and f are used as inter-frame candidate points. Optionally, φ of points e and f may be replaced with 4 of a parent node of the current point.

(4) Through rate-distortion optimization (RDO), one candidate point is selected from intra-frame candidate points and the inter-frame candidate points (for example, including the foregoing four inter-frame candidate points at most), and a reconstructed value of geometric position information of the selected candidate point is determined as a predicted value of geometric position information of the current point; and then a residual value of the geometric position information of the current point is determined based on an original value of the geometric position information of the current point and the predicted value of the geometric position information of the current point.

During selection of one candidate point from the intra-frame candidate points and the inter-frame candidate points through RDO, a residual value corresponding to each candidate point may be determined based on a reconstructed value of geometric position information of each candidate point in the intra-frame candidate points and the inter-frame candidate points and the original value of the geometric position information of the current point, and then the residual value corresponding to each candidate point may be encoded by using k-order Golomb to obtain an encoded codeword of the residual value. Then a candidate point with a smallest codeword length of the residual value is selected as a candidate point for predicting the geometric position information of the current point, that is, the residual value with the smallest codeword length is selected as the residual value of the current point.

Finally, parameters such as prediction mode, residual value, prediction tree structure, and quantize parameter of position information of the prediction tree node are encoded through continuous iterations to generate a binary bitstream.

A k-order Columbus encoding process is as follows:
1. Converting a to-be-encoded number into a binary form, removing the k least significant bits, and then adding 1;
2. Calculating the number of remaining bits, and subtracting 1 from the number of bits, to obtain the number of prefix zeros; and
3. For the k least significant bits removed in the first step, adding a prefix and appending the k bits back to a bit string tail, to obtain a final encoded codeword.

A k-order Columbus decoding process is as follows:
During parsing of a k-order exponential-Golomb code, a 1^{st} non-zero bit is searched for, starting from a current position of a bitstream, the number of zero bits found is indicated as leadingZeroBits, and A is calculated based on leadingZeroBits. A=2 (leadingZeroBits+k)-2k+values, where values indicated a value of (leadingZeroBits+k) bits following the 1^{st} non-zero bit.

The decoding side may perform predictive decoding through the following procedure:
(1) By continuously parsing the bitstream, reconstructing a prediction tree structure, traversing the prediction tree, and marking a previous encoded point of the to-be-encoded current point as point a.
(2) Decoding a prediction mode based on prediction tree node position information obtained by decoding the bitstream.
(3) If the prediction mode is an inter-frame mode, selecting, from the following at most four candidate points by using the prediction mode obtained by decoding, a candidate point for predicting the geometric position information of the current point:
   searching for point b in a reference frame of the current point, where point b is a point with a same φ and a same laserID as point a, or point b is a 1^{st} point with a same laserID as point a and with φ less than or equal to φ of point a; and marking a 1^{st} point with a same laserID as point a and with φ greater than φ of point b in the reference frame as point c, and marking a 1^{st} point with a same laserID as point a and with φ greater than φ of point c as point d, where points c and d are used as inter-frame candidate points of the current point; and
   obtaining a GMC reference frame by performing global motion compensation (global motion compensation, GMC) on the reference frame; searching for point g in the GMC reference frame, where point g is a point with a same φ and a same laserID as point a, or point g is a 1^{st} point with a same laserID as point a and with 4 less than or equal to φ of point a; marking a 1^{st} point with a same laserID as point g and with φ greater than φ of point g in the GMC reference frame as point e, and marking a 1^{st} point with a same laserID as point a and with φ greater than 4 of point e in the GMC frame as point f, where points e and f are used as inter-frame candidate points; and optionally, φ of points e and f may be replaced with 4 of a parent node of the current point.
(4) Obtaining a residual value and a quantization parameter of geometric position information of each point by parsing, and dequantizing the residual value to recover a reconstructed value of the geometric position information of each point, to finally complete reconstruction of the geometric position information on the decoding side.

It should be noted that, when the encoding side selects one candidate point from the intra-frame candidate points and the inter-frame candidate points through RDO, a residual value corresponding to each candidate point may be determined based on a reconstructed value of geometric position information of each candidate point in the intra-frame candidate points and the inter-frame candidate points and the original value of the geometric position information of the current point, and then the residual value corresponding to each candidate point may be encoded by using k-order Golomb to obtain an encoded codeword of the residual value. Then a candidate point corresponding to the residual value with a smallest codeword length is selected as a candidate point for predicting the geometric position information of the current point, that is, the residual value with the smallest codeword length is selected as the residual value of the current point. In this case, the residual value corresponding to each candidate point needs to be encoded, so as to select the residual value with the smallest codeword length. An encoding process of an unselected residual value reduces an encoding speed on the encoding side and increases complexity of the encoding side, especially when there are many candidate points. In view of this, this application provides a method for quickly calculating an encoded codeword of an exponential-Golomb code, which can improve the encoding speed on the encoding side and reduce complexity of the encoding side.

FIG. 22 is a schematic flowchart of an encoding method 100 according to an embodiment of this application.

As shown in FIG. 22, the encoding method 100 may include the following steps S110 to S140.

S110: An encoder determines at least one residual value based on an original value of geometric position information of a current point and a reconstructed value of geometric position information of at least one candidate point, where the at least one residual value includes a first residual value.

For example, the first residual value may be a residual value of any component corresponding to a first candidate point in the at least one candidate point. The any component may be any one of the following components: radius, φ, or laserIdx. Herein, radius represents a distance component, q represents a horizontal azimuth component, and laserIdx represents an index component of a lidar.

For example, the at least one residual value may include one first residual value, or may include a plurality of first residual values.

For example, when the at least one residual value may include one first residual value, the first residual value may be a residual value of a first component corresponding to the first candidate point, and the first component may be any one of the following components: radius, φ, or laserIdx. Herein, radius represents a distance component, φ represents a horizontal azimuth component, and laserIdx represents an index component of a lidar.

For another example, the at least one residual value may include a plurality of first residual values, that is, the plurality of first residual values may be residual values of a plurality of components corresponding to the first candidate point, and the plurality of components may include a plurality of the following components: radius, φ, or laserIdx. Herein, radius represents a distance component, φ represents a horizontal azimuth component, and laserIdx represents an index component of a lidar.

For example, the first residual value is value subjected to a rounding operation.

For example, the first residual value may be an original residual value or a processed value. For example, the first residual value may be a value obtained after quantization processing, or a value obtained after reduction or enlargement processing.

For example, the at least one candidate point may include an intra-frame candidate point and an inter-frame candidate point. The intra-frame candidate point is a subsequent point selected in a current frame in which the current point is located. The inter-frame candidate point is a candidate point selected, for the current frame, from a reference frame and/or a global motion compensation (GMC) reference frame obtained through GMC.

For example, as shown in FIG. 21, the inter-frame candidate point may include at least one of the following: point c, point d, point e, or point f.

Point c and point d may be determined as follows:
searching for point b in a reference frame of the current point, where point b is a point with a same φ and a same laserID as point a, or point b is a 1^{st} point with a same laserID as point a and with q less than or equal to φ of point a; and marking a 1^{st} point with a same laserID as point a and with φ greater than φ of point b in the reference frame as point c, and marking a 1^{st} point with a same laserID as point a and with φ greater than φ of point c as point d.

Point e and point f may be determined as follows:
obtaining a GMC reference frame by performing global motion compensation (GMC) on the reference frame; searching for point g in the CMC reference frame, where point g is a point with a same φ and a same laserID as point a, or point g is a 1^{st} point with a same laserID as point a and with φ less than or equal to 4 of point a; marking a 1^{st} point with a same laserID as point g and with φ greater than q of point g in the GMC reference frame as point e, and marking a 1^{st} point with a same laserID as point a and with φ greater than φ of point e in the GMC reference frame as point f; where optionally, φ of point e and point f may be replaced with 4 of a parent node of the current point.

S120: Before encoding the first residual value, the encoder determines a codeword length of the at least one residual value.

For example, before encoding the first residual value, the encoder may determine the codeword length of the at least one residual value through estimation. For example, before encoding the first residual value, the encoder may determine the codeword length of the at least one residual value by using an estimation model. It should be noted that the estimation model may be a mathematical model, a learning model (such as a machine learning model), or another type of model, which is not specifically limited in this application.

For example, the at least one residual value may be at least one of the residual values, or a part of the at least one residual value.

S130: The encoder determines, based on the codeword length of the at least one residual value, that a predicted residual value of the geometric position information of the current point includes the first residual value.

For example, the encoder may determine, through comparison of the codeword length of the at least one residual value, that the predicted residual value of the geometric position information of the current point includes the first residual value.

For example, when the first residual value may be the residual value of the first component corresponding to the first candidate point, and if a codeword length of the first residual value is a smallest value of the codeword length of the at least one residual value, the encoder determines that the predicted residual value of the geometric position information of the current point includes the first residual value. Further, the predicted residual value of the geometric position information of the current point may further include a residual value of another component corresponding to the first candidate point, that is, the encoder may also encode a residual value of another component corresponding to the first candidate point.

For another example, the at least one residual value may include a plurality of first residual values, that is, when the plurality of first residual values may be residual values of a plurality of components corresponding to the first candidate point, the encoder may compare codeword lengths of the at least one residual value. When determining that a total codeword length of the residual values of the plurality of components corresponding to the first candidate point is a smallest value of a total codeword length of residual values of a plurality of components corresponding to each of the at least one candidate point, the encoder determines that the predicted residual value of the geometric position information of the current point includes the residual values of the plurality of components corresponding to the first candidate point. That is, the encoder determines that the predicted residual value of the geometric position information of the current point includes the plurality of first residual values.

S140: The encoder encodes the first residual value.

For example, the current point may be used as a node in a prediction tree, and the encoder may encode information such as a prediction mode, a residual value, a prediction tree structure, and a quantize parameter of the node in the prediction tree, to generate a binary bitstream.

In this embodiment, at least one residual value is determined based on an original value of geometric position information of a current point and a reconstructed value of geometric position information of at least one candidate point, where the at least one residual value includes a first residual value; before the first residual value is encoded, a codeword length of the at least one residual value is determined; it is determined, based on the codeword length of the at least one residual value, that a predicted residual value of the geometric position information of the current point includes the first residual value; and the first residual value is encoded. According to the above method, the codeword length of the at least one residual value is determined without precoding, so that an encoding speed of the encoder can be improved, and encoding complexity of the encoder can be reduced.

In some embodiments, S120 may include that:

the encoder first determines a first length based on the first residual value and an order of an exponential-Golomb algorithm; and then determines a codeword length of the first residual value based on the first length.

It should be noted that the encoder first determines the first length based on the first residual value and the order of the exponential-Golomb algorithm; and then determines the codeword length of the first residual value based on the first length, where the codeword length of the first residual value may also be referred to as an exponential-Golomb codeword length of the first residual value.

In some embodiments, the encoder determines the first length based on the first residual value and the order of the exponential-Golomb algorithm by performing an exponential operation and a logarithmic operation.

In other words, the encoder may estimate the first length by using an estimation model based on the first residual value and the order of the exponential-Golomb algorithm. The estimation model may be a mathematical model established based on an exponential operation and a logarithmic operation.

In some embodiments, the encoder determines the first length based on the first residual value and the order of the exponential-Golomb algorithm according to the following formula:

$$2 \times ⌊ {log}_{2} ( A + {2}^{k} ) ⌋ - k + 1 ,$$

where A represents the first residual value, k represents the order of the exponential-Golomb algorithm, and └┘ represents a round-down operation.

In other words, the encoder determines the first length based on the first residual value and the order of the exponential-Golomb algorithm according to the following mathematical model:

$$2 \times ⌊ {log}_{2} ( A + {2}^{k} ) ⌋ - k + 1 .$$

In some embodiments, the encoder determines a suffix codeword length of an encoded codeword of the first residual value based on the first residual value and the order of the exponential-Golomb algorithm; and then determines the first length based on the suffix codeword length and the order of the exponential-Golomb algorithm.

For example, a logical structure of the encoded codeword of the first residual value is: [(n-k)] [1] [n]. The encoded codeword of the first residual value includes a prefix codeword (that is, [(n-k)]) of the encoded codeword of the first residual value and a suffix codeword (that is, [n]) of the encoded codeword of the first residual value. The prefix codeword is connected to the suffix codeword through 1. The prefix codeword may include n-k consecutive zeros, and the suffix codeword may include n bits. In other words, n represents the suffix codeword length of the encoded codeword of the first residual value.

In some embodiments, the encoder determines the suffix codeword length of the encoded codeword of the first residual value based on the first residual value and the order of the exponential-Golomb algorithm by performing an exponential operation and a logarithmic operation.

In other words, the encoder determines the suffix codeword length of the encoded codeword of the first residual value based on the first residual value and the order of the exponential-Golomb algorithm by using an estimation model. The estimation model may be a mathematical model established based on an exponential operation and a logarithmic operation.

In some embodiments, the encoder determines the suffix codeword length based on the first residual value and the order of the exponential-Golomb algorithm according to the following formula:

$$⌊ {log}_{2} ( A + {2}^{k} ) ⌋ ,$$

where A represents the first residual value, k represents the order of the exponential-Golomb algorithm, and └┘ represents a round-down operation.

In other words, the encoder determines the suffix codeword length based on the first residual value and the order of the exponential-Golomb algorithm according to the following mathematical model:

$$⌊ {log}_{2} ( A + {2}^{k} ) ⌋ .$$

In some embodiments, the encoder determines the suffix codeword length of the encoded codeword of the first residual value based on the suffix codeword length and the order of the exponential-Golomb algorithm by performing an addition operation, a multiplication operation, and a subtraction operation.

In other words, the encoder determines the suffix codeword length of the encoded codeword of the first residual value based on the suffix codeword length and the order of the exponential-Golomb algorithm by using an estimation model. The estimation model may be a mathematical model established based on the addition operation, the multiplication operation, and the subtraction operation.

In some embodiments, the encoder determines the first length based on the suffix codeword length and the order of the exponential-Golomb algorithm according to the following formula:

$$2 \times n - k + 1 ,$$

where A represents the first residual value, n represents the suffix codeword length, and k represents the order of the exponential-Golomb algorithm.

In other words, the encoder determines the first length based on the suffix codeword length and the order of the exponential-Golomb algorithm according to the following mathematical model:

$$2 \times n - k + 1 .$$

In some embodiments, the encoder determines the first length as the codeword length of the first residual value.

For example, the encoder determines the first length as the codeword length of the first residual; then encodes the first residual value when the first residual value is determined as the residual value of the geometric position information of the current point based on the codeword length of the first residual value.

In some embodiments, the encoder determines the codeword length of the first residual value based on the first length and the order of the exponential-Golomb algorithm.

For example, the encoder determines the codeword length of the first residual value based on the first length and the order of the exponential-Golomb algorithm; and then encodes the first residual value when the first residual value is determined as the residual value of the geometric position information of the current point based on the codeword length of the first residual value.

In some embodiments, the encoder determines the codeword length of the first residual value according to the following formula:

$$max ( k + 1 , L ) ,$$

where k represents the order of the exponential-Golomb algorithm, L represents the first length, and max ( ) represents calculating a maximum value.

Certainly, in another alternative embodiment, an average value of k+1 and L may be determined as the codeword length of the first residual value, which is not specifically limited in this application.

In some embodiments, S130 may include:
if the first residual value is a residual value with a smallest codeword length among the first residual value and the second residual value, determining that the predicted residual value of the geometric position information of the current point includes the first residual value,
where the first residual value is a residual value corresponding to a first component and determined based on the following information: the original value of the geometric position information of the current point and a reconstructed value of geometric position information of a first candidate point in the at least one candidate point; and the second residual value is a residual value corresponding to the first component and determined based on the following information: the original value of the geometric position information of the current point and a reconstructed value of geometric position information of a candidate point other than the first candidate point in the at least one candidate point.

For example, a codeword length of the first residual value may be: a residual value corresponding to a component q and determined by the original value of the geometric position information of the current point and the reconstructed value of the geometric position information of the first candidate point.

For example, if a codeword length of the first residual value may be a residual value corresponding to a component q and determined by the original value of the geometric position information of the current point and the reconstructed value of the geometric position information of the first candidate point, correspondingly, the codeword length of the second residual value is a residual value corresponding to the component q and determined by the original value of the geometric position information of the current point and a reconstructed value of geometric position information of a candidate point other than the first candidate point in the at least one candidate point.

Certainly, in another alternative embodiment, the first residual value and the second residual value may also be residual values corresponding to another component (for example, a radius component), which is not specifically limited in this application.

In some embodiments, S130 may include:
if at least one first residual value in the at least one residual value is at least one residual value with a smallest total codeword length among the at least one first residual value and at least one third residual value, determining that the predicted residual value of the geometric position information of the current point includes the first residual value, where the at least one first residual value is a residual value corresponding to at least one component and determined based on the following information: the original value of the geometric position information of the current point and a reconstructed value of geometric position information of a first candidate point in the at least one candidate point; and the at least one third residual value is at least one residual value corresponding to the at least one component and determined based on the following information: the original value of the geometric position information of the current point and a reconstructed value of geometric position information of a candidate point other than the first candidate point in the at least one candidate point.

For example, the at least one first residual value includes a residual value corresponding to a radius component and a residual value corresponding to a component q (the first residual value may be a residual value determined based on the original value of the geometric position information of the current point and the reconstructed value of the geometric position information of the first candidate point). A total codeword length of the at least one first residual value is a sum of the following two lengths: a codeword length of a residual value corresponding to the radius component and determined by the original value of the geometric position information of the current point and the reconstructed value of the geometric position information of the first candidate point, and a codeword length of a residual value corresponding to the component q and determined by the original value of the geometric position information of the current point and the reconstructed value of the geometric position information of the first candidate point.

For example, if the total codeword length of the at least one first residual value is the sum of the codeword length of the residual value corresponding to the radius component and determined by the original value of the geometric position information of the current point and the reconstructed value of the geometric position information of the first candidate point, and the codeword length of the residual value corresponding to the component q and determined by the original value of the geometric position information of the current point and the reconstructed value of the geometric position information of the first candidate point, a total length of an encoded codeword of the at least one third residual value is a sum of the following two lengths: a codeword length of a residual value corresponding to the radius component and determined by the original value of the geometric position information of the current point and a reconstructed value of geometric position information of a candidate point other than the first candidate point in the at least one candidate point, and a codeword length of a residual value corresponding to the component q and determined by the original value of the geometric position information of the current point and the reconstructed value of the geometric position information of the candidate point other than the first candidate point in the at least one candidate point.

A derivation process of 2×[log₂(A+2^{k})]−k+1 is described as follows.

Assuming that A represents a to-be-encoded value (for example, the first residual value described above), and n represents a suffix length of an encoded codeword of the to-be-encoded value:
when k=0, that is, when 0-order exponential-Golomb is used for encoding, the following is satisfied:

$${2}^{0} + {2}^{1} + {2}^{2} + … + {2}^{n - 1} \leq A \leq {2}^{0} + {2}^{1} + {2}^{2} + … + {2}^{n} - 1 .$$

It may be learned from the summation formula for geometric sequence (that is, Sₙ=a₁(1−q″)/(1−q), where a₁ is the first term, q is a common ratio of the geometric sequence, and Sₙ is a sum of the first n terms) that:

$${2}^{n} - 1 \leq A \leq {2}^{n + 1} - 2 n$$

A suffix length n of a 0-order exponential-Golomb encoded codeword may be obtained by performing conversion on 2″-1≤A:

$$⌊ log 2 ( A + 1 ) ⌋ .$$

It may be learned from the nature of the 0-order exponential-Golomb (that is, a prefix codeword length is equal to a suffix codeword length) that a 0-order exponential-Golomb encoded codeword length is:

$$⌊ {log}_{2} ( A + 1 ) ⌋ + ⌊ {log}_{2} ( A + 1 ) ⌋ + 12 \times ⌊ {log}_{2} ( A + 1 ) ⌋ + 1.$$

Since an encoded codeword length encoded using 0-order exponential-Golomb is greater than 1, the 0-order exponential-Golomb encoded codeword length is:

$$max ( 1 , 2 \times ⌊ {log}_{2} ( A + 1 ) ⌋ + 1 ) .$$

When k=1, that is, when 1-order exponential-Golomb is used for encoding, the following is satisfied:

$${2}^{1} + {2}^{2} + {2}^{3} + ⋯ + {2}^{n - 1} \leq A \leq {2}^{1} + {2}^{2} + {2}^{3} + ⋯ + {2}^{n} - 1 .$$

It may be learned from the summation formula for geometric sequence (that is, Sₙ=a₁(1−q″)/(1−q), where a₁ is the first term, q is a common ratio of the geometric sequence, and Sₙ is a sum of the first n terms) that:

$${2}^{n} - 2 \leq A \leq {2}^{n + 1} - 3 ( n is greater or equal to 1 ) .$$

A suffix length n of a 1-order exponential-Golomb encoded codeword may be obtained by performing conversion on 2ⁿ−2:

$$⌊ {log}_{2} ( A + 2 ) ⌋ .$$

It may be learned from the nature of the 1-order exponential-Golomb (that is, a prefix codeword length is equal to a suffix codeword length minus 1) that a 1-order exponential-Golomb encoded codeword length is:

$$⌊ l {log}_{2} ( A + 2 ) ⌋ + ⌊ {log}_{2} ( A + 2 ) ⌋ - 1 + 1 , that is , 2 \times ⌊ {log}_{2} ( A + 2 ) ⌋ .$$

Since an encoded codeword length encoded using 1-order exponential-Golomb is greater than 2, the 1-order exponential-Golomb encoded codeword length is:

$$max ( 2 , 2 \times ⌊ {log}_{2} ( A + 2 ) ⌋ ) .$$

When k=2, that is, when 1-order exponential-Golomb is used for encoding, the following is satisfied:

$${2}^{2} + {2}^{3} + … + {2}^{n - 1} \leq A \leq {2}^{2} + {2}^{3} + … + {2}^{n} - 1 .$$

It may be learned from the summation formula for geometric sequence (that is, Sₙ=a₁(1−q″)/(1−q), where a₁ is the first term, q is a common ratio of the geometric sequence, and Sₙ is a sum of the first n terms) that:

$${2}^{n} - 4 \leq A \leq {2}^{n + 1} - 5 ( n is greater than or equal to 2 ) .$$

A suffix length n of a 2-order exponential-Golomb encoded codeword may be obtained by performing conversion on 2ⁿ−4:

$$⌊ {log}_{2} ( A + 4 ) ⌋ ,$$

where └┤ indicates rounding down.

It may be learned from the nature of the 2-order exponential-Golomb (that is, a prefix codeword length is equal to a suffix codeword length minus 2) that a 2-order exponential-Golomb encoded codeword length is:

$$⌊ {log}_{2} ( A + 4 ) ⌋ + ⌊ {log}_{2} ( A + 4 ) ⌋ - 2 + 1 , that is , 2 \times ⌊ {log}_{2} ( A + 4 ) ⌋ - 1.$$

Since an encoded codeword length encoded using 2-order exponential-Golomb is greater than 3, the 2-order exponential-Golomb encoded codeword length is:

$$max ( 3 , 2 \times ⌊ {log}_{2} ( A + 4 ) ⌋ - 1 ) .$$

It may be learned from the foregoing analysis that k-order exponential-Golomb encoded codeword length is:

$$max ( k + 1+ , 2 \times ⌊ {log}_{2} ( A + {2}^{k} ) ⌋ - k + 1 ) .$$

In embodiments of this application, a codeword length of a residual value is estimated by using a construction algorithm of a mathematical model, so that an encoding speed of an encoding side can be improved and complexity of the encoding side can be reduced.

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be made, and these simple variations all fall within the protection scope of this application. For example, specific technical features described in the foregoing specific implementations may be combined in any suitable manner without contradiction. To avoid unnecessary repetition, various possible combination manners are not separately described in this application. For another example, any combination of different implementations of this application may be made, provided that the combination is not contrary to the idea of this application, the combination shall also be considered as the content disclosed in this application. It should be further understood that, in the method embodiments of this application, sequence numbers of the foregoing processes described above do not mean execution sequences. The execution sequences of the processes shall be determined according to functions and internal logic of the processes, and shall not be construed as any limitation on the implementation processes of embodiments of this application.

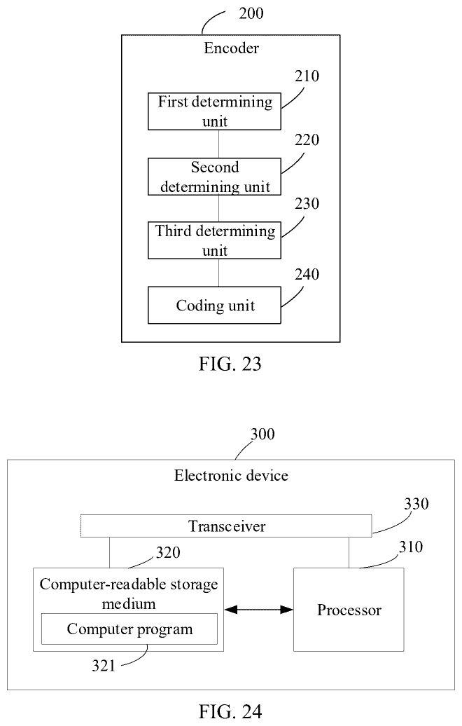

The method embodiments of this application are described in detail above. Apparatus embodiments of this application are described below in detail with reference to FIG. 23.

FIG. 23 is a schematic block diagram of an encoder 200 according to an embodiment of this application.

As shown in FIG. 23, the encoder 200 may include:
a first determining unit 210, configured to determine at least one residual value based on an original value of geometric position information of a current point and a reconstructed value of geometric position information of at least one candidate point, where the at least one residual value includes a first residual value;
a second determining unit 220, configured to: determine a codeword length of the at least one residual value before the first residual value is encoded;
a third determining unit 230, configured to: determine, based on the codeword length of the at least one residual value, that a predicted residual value of the geometric position information of the current point includes the first residual value; and
an encoding unit 240, configured to encode the first residual value.

In some embodiments, the second determining unit 220 is specifically configured to:
determine a first length based on the first residual value and an order of an exponential-Golomb algorithm; and
determine a codeword length of the first residual value based on the first length.

In some embodiments, the second determining unit 220 is specifically configured to:
determine the first length based on the first residual value and the order of the exponential-Golomb algorithm by performing an exponential operation and a logarithmic operation.

In some embodiments, the second determining unit 220 is specifically configured to:
determine the first length based on the first residual value and the order of the exponential-Golomb algorithm according to the following formula:

$$2 \times ⌊ {log}_{2} ( A + {2}^{k} ) ⌋ - k + 1 ,$$

where A represents the first residual value, k represents the order of the exponential-Golomb algorithm, and └┘ represents a round-down operation.

In some embodiments, the second determining unit 220 is specifically configured to:
determine a suffix codeword length of an encoded codeword of the first residual value based on the first residual value and the order of the exponential-Golomb algorithm; and
determine the first length based on the suffix codeword length and the order of the exponential-Golomb algorithm.

In some embodiments, the second determining unit 220 is specifically configured to:
determine the suffix codeword length of the encoded codeword of the first residual value based on the first residual value and the order of the exponential-Golomb algorithm by performing an exponential operation and a logarithmic operation.

In some embodiments, the second determining unit 220 is specifically configured to:
determine the suffix codeword length based on the first residual value and the order of the exponential-Golomb algorithm according to the following formula:

$$⌊ {log}_{2} ( A + {2}^{k} ) ⌋ ,$$

where A represents the first residual value, k represents the order of the exponential-Golomb algorithm, and └┘ represents a round-down operation.

In some embodiments, the second determining unit 220 is specifically configured to:
determine the first length based on the suffix codeword length and the order of the exponential-Golomb algorithm according to the following formula:

$$2 \times n - k + 1 ,$$

where A represents the first residual value, n represents the suffix codeword length, and k represents the order of the exponential-Golomb algorithm.

In some embodiments, the second determining unit 220 is specifically configured to: determine the first length as the codeword length of the first residual value.

In some embodiments, the second determining unit 220 is specifically configured to: determine the codeword length of the first residual value based on the first length and the order of the exponential-Golomb algorithm.

In some embodiments, the second determining unit 220 is specifically configured to: determine the codeword length of the first residual value according to the following formula:

$$max ( k + 1 , L ) ,$$

where k represents the order of the exponential-Golomb algorithm, L represents the first length, and max ( ) represents calculating a maximum value.

In some embodiments, the third determining unit 230 is specifically configured to:
if the first residual value is a residual value with a smallest codeword length among the first residual value and the second residual value, determining that the predicted residual value of the geometric position information of the current point includes the first residual value,
where the first residual value is a residual value corresponding to a first component and determined based on the following information: the original value of the geometric position information of the current point and a reconstructed value of geometric position information of a first candidate point in the at least one candidate point; and the second residual value is a residual value corresponding to the first component and determined based on the following information: the original value of the geometric position information of the current point and a reconstructed value of geometric position information of a candidate point other than the first candidate point in the at least one candidate point.

In some embodiments, the third determining unit 230 is specifically configured to:
if at least one first residual value in the at least one residual value is at least one residual value with a smallest total codeword length among the at least one first residual value and at least one third residual value, determine that the predicted residual value of the geometric position information of the current point includes the first residual value,
where the at least one first residual value is a residual value corresponding to at least one component and determined based on the following information: the original value of the geometric position information of the current point and a reconstructed value of geometric position information of a first candidate point in the at least one candidate point; and the at least one third residual value is at least one residual value corresponding to the at least one component and determined based on the following information: the original value of the geometric position information of the current point and a reconstructed value of geometric position information of a candidate point other than the first candidate point in the at least one candidate point.

It should be understood that the apparatus embodiments may correspond to the method embodiments. For similar descriptions, one may refer to the method embodiments. Specifically, the encoder 200 shown in FIG. 23 may correspond to an entity performing the method 100 in embodiments of this application. That is, the foregoing and other operations and/or functions of the units in the encoder 200 are separately used to implement corresponding procedures in the methods such as the method 100.

It should be further understood that the units in the encoder 200 in embodiments of this application may be separately or all combined into one or more additional units, or some unit(s) in the encoder 200 may be further divided into a plurality of smaller units in functions. This can achieve same operations without affecting implementation of the technical effects of embodiments of this application. The foregoing units are obtained through partitioning based on logical functions. In actual applications, a function of one unit may also be implemented by a plurality of units, or a function of a plurality of units may be implemented by one unit. In another embodiment of this application, the encoder 200 may also include other units. In actual application, these functions may also be implemented with assistance of the other units, and may be implemented by a plurality of units cooperatively. According to another embodiment of this application, the encoder 200 in embodiments of this application can be constructed and the encoding method in embodiments of this application can be implemented, by running a computer program (including program code) capable of executing the steps in the corresponding method on a general-purpose computing device of a general-purpose computer including processing elements and storage elements such as a central processing unit (CPU), a random access storage medium (RAM), and a read-only storage medium (ROM). The computer program may be recorded on, for example, a computer-readable storage medium, loaded into an electronic device through the computer-readable storage medium, and run therein to implement the corresponding method in embodiments of this application.

In other words, the units mentioned above may be implemented in the form of hardware, may be implemented in the form of software instructions, or may be implemented in the form of a combination of hardware and software. Specifically, the steps in the method embodiments in embodiments of this application may be completed by using a hardware integrated logic circuit in a processor and/or instructions in a software form. The steps in the methods disclosed with reference to embodiments of this application may be directly performed by a hardware decoding processor, or may be performed by using a combination of hardware in the decoding processor and software. Optionally, the software may be located in a mature storage medium in the art, such as a random access memory, a flash memory, a read-only memory, a programmable read-only memory, an electrically erasable programmable memory, or a register. The storage medium is located in a memory. The processor reads information from the memory, and performs the steps in the foregoing method embodiments in combination with hardware in the processor.

FIG. 24 is a schematic diagram of a structure of an electronic device 300 according to an embodiment of this application.

As shown in FIG. 24, the electronic device 300 includes at least a processor 310 and a computer-readable storage medium 320. The processor 310 and the computer-readable storage medium 320 may be connected via a bus or in another manner. The computer-readable storage medium 320 is configured to store a computer program 321. The computer program 321 includes computer instructions. The processor 310 is configured to execute the computer instructions stored in the computer-readable storage medium 320. The processor 310 is a computing core and control core of the electronic device 300, and is adapted to implement one or more computer instructions, and specifically adapted to load and execute one or more computer instructions to implement corresponding method procedures or corresponding functions.

For example, the processor 310 may also be referred to as a central processing unit (CPU). The processor 310 may include, but is not limited to: a general-purpose processor, a digital signal processor (DSP), an application-specific integrated circuit (ASIC), a field-programmable gate array (FPGA) or another programmable logic device, a transistor logic device, or a discrete hardware component.

For example, the computer-readable storage medium 320 may be a high-speed RAM memory, or may be a non-volatile memory (Non-Volatile Memory), for example, at least one magnetic disk memory; and optionally, may be at least one computer-readable storage medium that is located far away from the foregoing processor 310. Specifically, the computer-readable storage medium 320 includes, but is not limited to: a volatile memory and/or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM).

For example, the electronic device 300 may be an encoder or encoding framework involved in embodiments of this application; a first computer instruction is stored in the computer-readable storage medium 320; and the processor 310 loads and executes the first computer instruction stored in the computer-readable storage medium 320 to implement corresponding steps in the encoding method provided in embodiments of this application. In other words, the first computer instruction in the computer-readable storage medium 320 is loaded by the processor 310 and the corresponding steps are executed. To avoid repetition, details are not described herein.

According to another aspect of this application, this application further provides an encoding and decoding system, including the encoder mentioned above and a decoder.

According to another aspect of this application, this application further provides a computer-readable storage medium (Memory), where the computer-readable storage medium is a memory device in the electronic device 300 and configured to store programs and data, for example, a computer-readable storage medium 320. It may be understood that the computer-readable storage medium 320 herein may include both a built-in storage medium in the electronic device 300 and an extended storage medium supported by the electronic device 300. The computer-readable storage medium provides storage space in which an operating system of the electronic device 300 is stored. In addition, one or more computer instructions suitable for being loaded and executed by the processor 310 are also stored in the storage space. These computer instructions may be one or more computer programs 321 (including program code).

According to another aspect of this application, this application further provides a computer program product or a computer program, where the computer program product or the computer program includes computer instructions, stored in a computer-readable storage medium, and is, for example, a computer program 321. In this case, the data processing device 300 may be a computer, the processor 310 reads the computer instructions from a computer-readable storage medium 320, and the processor 310 executes the computer instructions, so that the computer executes the encoding methods provided in various optional manners mentioned above.

In other words, when software is used to implement embodiments, the foregoing embodiments may be implemented completely or partially in a form of a computer program product. The computer program product includes one or more computer instructions. When the computer program instructions are loaded and executed on the computer, procedures of embodiments of this application are run in whole or in part or functions of embodiments of this application are achieved. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (DSL) manner or a wireless (for example, infrared, wireless, and microwave) manner.

A person of ordinary skill in the art may be aware that, in combination with the examples described in embodiments disclosed in this specification, units and procedure steps may be implemented by electronic hardware or a combination of computer software and electronic hardware. Whether the functions are performed by hardware or software depends on particular applications and design constraints of the technical solutions. A person skilled in the art may use different methods to implement the described functions for each specific application, but it should not be considered that the implementation goes beyond the scope of this application.

Finally, it should be noted that the foregoing content is merely specific implementations of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An encoding method, comprising:
determining at least one residual value based on an original value of geometric position information of a current point and a reconstructed value of geometric position information of at least one candidate point, wherein the at least one residual value comprises a first residual value;
determining a codeword length of the at least one residual value before the first residual value is encoded;
determining, based on the codeword length of the at least one residual value, that a predicted residual value of the geometric position information of the current point comprises the first residual value; and
encoding the first residual value.

2. The method according to claim 1, wherein the determining the codeword length of the at least one residual value comprises:
determining a first length based on the first residual value and an order of an exponential-Golomb algorithm; and
determining a codeword length of the first residual value based on the first length.

3. The method according to claim 2, wherein the determining the first length based on the first residual value and the order of the exponential-Golomb algorithm comprises:
determining the first length based on the first residual value and the order of the exponential-Golomb algorithm by performing an exponential operation and a logarithmic operation.

4. The method according to claim 3, wherein the determining the first length based on the first residual value and the order of the exponential-Golomb algorithm by performing the exponential operation and the logarithmic operation comprises:
determining the first length based on the first residual value and the order of the exponential-Golomb algorithm according to the following formula:
$$2 \times ⌊ {log}_{2} ( A + {2}^{k} ) ⌋ - k + 1 ,$$
wherein A represents the first residual value, k represents the order of the exponential-Golomb algorithm, and └┘ represents a round-down operation.

5. The method according to claim 2, wherein the determining the first length based on the first residual value and the order of the exponential-Golomb algorithm comprises:
determining a suffix codeword length of an encoded codeword of the first residual value based on the first residual value and the order of the exponential-Golomb algorithm; and
determine the first length based on the suffix codeword length and the order of the exponential-Golomb algorithm.

6. The method according to claim 5, wherein the determining the suffix codeword length of the encoded codeword of the first residual value based on the first residual value and the order of the exponential-Golomb algorithm comprises:
determining the suffix codeword length of the encoded codeword of the first residual value based on the first residual value and the order of the exponential-Golomb algorithm by performing an exponential operation and a logarithmic operation.

7. The method according to claim 6, wherein the determining the suffix codeword length of the encoded codeword of the first residual value based on the first residual value and the order of the exponential-Golomb algorithm by performing the exponential operation and the logarithmic operation comprises:
determining the suffix codeword length based on the first residual value and the order of the exponential-Golomb algorithm according to the following formula:
$$⌊ {log}_{2} ( A + {2}^{k} ) ⌋ ,$$
wherein A represents the first residual value, k represents the order of the exponential-Golomb algorithm, and └┘ represents a round-down operation.

8. The method according to claim 5, wherein the determining the first length based on the suffix codeword length and the order of the exponential-Golomb algorithm comprises:
determining the first length based on the suffix codeword length and the order of the exponential-Golomb algorithm according to the following formula:
$$2 \times n - k + 1 ,$$
wherein A represents the first residual value, n represents the suffix codeword length, and k represents the order of the exponential-Golomb algorithm.

9. The method according to claim 2, wherein the determining the codeword length of the first residual value based on the first length comprises:
determining the first length as the codeword length of the first residual value.

10. The method according to claim 2, wherein the determining the codeword length of the first residual value based on the first length comprises:
determining the codeword length of the first residual value based on the first length and the order of the exponential-Golomb algorithm.

11. The method according to claim 10, wherein the determining the codeword length of the first residual value based on the first length and the order of the exponential-Golomb algorithm comprises:
determining the codeword length of the first residual value according to the following formula:
$$max ( k + 1 , L ) ,$$
wherein k represents the order of the exponential-Golomb algorithm, L represents the first length, and max ( ) represents calculating a maximum value.

12. The method according to claim 1, wherein the determining, based on the codeword length of the at least one residual value, that the predicted residual value of the geometric position information of the current point comprises the first residual value comprises:
if the first residual value is a residual value with a smallest codeword length among the first residual value and the second residual value, determining that the predicted residual value of the geometric position information of the current point comprises the first residual value, wherein the first residual value is a residual value corresponding to a first component and determined based on the following information: the original value of the geometric position information of the current point and a reconstructed value of geometric position information of a first candidate point in the at least one candidate point; and the second residual value is a residual value corresponding to the first component and determined based on the following information: the original value of the geometric position information of the current point and a reconstructed value of geometric position information of a candidate point other than the first candidate point in the at least one candidate point.

13. The method according to claim 1, wherein the determining, based on the codeword length of the at least one residual value, that the predicted residual value of the geometric position information of the current point comprises the first residual value comprises:
if at least one first residual value in the at least one residual value is at least one residual value with a smallest total codeword length among the at least one first residual value and at least one third residual value, determining that the predicted residual value of the geometric position information of the current point comprises the first residual value,
wherein the at least one first residual value is a residual value corresponding to at least one component and determined based on the following information: the original value of the geometric position information of the current point and a reconstructed value of geometric position information of a first candidate point in the at least one candidate point; and the at least one third residual value is at least one residual value corresponding to the at least one component and determined based on the following information: the original value of the geometric position information of the current point and a reconstructed value of geometric position information of a candidate point other than the first candidate point in the at least one candidate point.

14. An encoder, comprising a memory and a processor, wherein the memory is configured to store a computer program, and the processor is configured to execute the computer program stored in the memory to perform operations comprising:
determining at least one residual value based on an original value of geometric position information of a current point and a reconstructed value of geometric position information of at least one candidate point, wherein the at least one residual value comprises a first residual value;
determining a codeword length of the at least one residual value before the first residual value is encoded;
determining, based on the codeword length of the at least one residual value, that a predicted residual value of the geometric position information of the current point comprises the first residual value; and
encoding the first residual value.

15. The encoder according to claim 14, wherein the encoder is specifically configured to:
determine a first length based on the first residual value and an order of an exponential-Golomb algorithm; and
determine a codeword length of the first residual value based on the first length.

16. The encoder according to claim 15, wherein the encoder is specifically configured to:
determine the first length based on the first residual value and the order of the exponential-Golomb algorithm by performing an exponential operation and a logarithmic operation.

17. The encoder according to claim 16, wherein the encoder is specifically configured to:
determine the first length based on the first residual value and the order of the exponential-Golomb algorithm according to the following formula:
$$2 \times ⌊ {log}_{2} ( A + {2}^{k} ) ⌋ - k + 1 ,$$
wherein A represents the first residual value, k represents the order of the exponential-Golomb algorithm, and └┘ represents a round-down operation.

18. The encoder according to claim 15, wherein the encoder is specifically configured to:
determine a suffix codeword length of an encoded codeword of the first residual value based on the first residual value and the order of the exponential-Golomb algorithm; and
determine the first length based on the suffix codeword length and the order of the exponential-Golomb algorithm.

19. The encoder according to claim 18, wherein the encoder is specifically configured to:
determine the suffix codeword length of the encoded codeword of the first residual value based on the first residual value and the order of the exponential-Golomb algorithm by performing an exponential operation and a logarithmic operation.

20. A non-transitory computer readable medium storing a computer program/instruction and a bitstream, wherein the computer program/instruction is executed by a processor to implement the method according claim 1 to generate the bitstream.
